(19) United States
(12) Patent Application Publication
(10) Pub. No.: US 2022/0191725 A1
(43) Pub. Date: Jun. 16, 2022

(54) METHODS PROVIDING ACK/NACK FEEDBACK BASED ON REFERENCE SIGNAL RECEIVED POWER AND RELATED WIRELESS DEVICES

(71) Applicant: Telefonaktiebolaget LM Ericsson (publ), Stockholm (SE)

(72) Inventors: Shehzad Ali ASHRAF, Aachen (DE); Hieu DO, Järfälla (SE)

(21) Appl. No.: 17/600,410

(22) PCT Filed: Mar. 2, 2020
(86) PCT No.: PCT/EP2020/055420

§ 371 Date: Sep. 30, 2021

Related U.S. Application Data
(60) Provisional application No. 62/828,322, filed on Apr. 2, 2019.

(51) Int. Cl. H04W 24/10; H04B 17/318; H04L 5/00; H04W 4/40

(52) U.S. Cl. CPC H04W 24/10; H04B 17/318; H04W 4/40; H04L 5/0051; H04L 5/0053

(57) ABSTRACT

A method is provided to operate a first wireless device associated with a group including the first wireless device and a second wireless device. A data packet is received from the second wireless device of the group. A reference signal received power RSRP is measured based on a reference signal received from the second wireless device of the group. It is then determined whether or not to transmit Acknowledgement/Negative ACK/NACK feedback for the data packet based on a comparison between the RSRP and an RSRP threshold. Related wireless devices, computer programs, and computer program products are also discussed.

### TECHNICAL FIELD

The present disclosure relates generally to wireless communications, and more particularly, to methods providing wireless groupcast communications and related wireless devices.

### BACKGROUND

LTE Vehicle-to-anything (V2X) communications are discussed below.

Long Term Evolution LTE V2X was first specified by 3GPP in Release 14 and was enhanced in Release 15. LTE V2X provides basic features and enhancements that allow for vehicular communications. One of the most relevant aspects is the introduction of direct vehicle-to-vehicle (V2V) communication functionalities. The specifications support other types of vehicle-to-anything (V2X) communications, including V2P (vehicle-to-pedestrian or pedestrian-to-vehicle), V2I (vehicle-to-infrastructure), etc., as shown in FIG. 1.

FIG. 1 illustrates V2X scenarios for an LTE-based Radio Access Network NW. As shown in FIG. 1, V2I (vehicle-to-infrastructure) communications may be provided between a vehicle and the radio access network RAN (e.g., between V2X wireless device UE-1 and eNB or between V2X wireless device UE-2 and eNB), V2V (vehicle-to-vehicle) communications may be provided directly between different vehicles (e.g., between V2X wireless devices UE-1 and UE-3, or between V2X wireless devices UE-2 and UE-3) without communicating through the radio access network, and V2P (vehicle-to-pedestrian or pedestrian-to-vehicle) communications may be provided directly between a vehicle and a device held/carried by the pedestrian (e.g., a smartphone, a tablet computer, etc.). V2X communications are meant to include any/all of V2I, V2P, and V2V communications.

These direct communication functionalities are built upon LTE D2D (device-to-device), also known as ProSe (Proximity Services), as first specified in the Release 12 of LTE, and include many important enhancements targeting the specific characteristics of vehicular communications. For example, LTE V2X operation is possible with and without network coverage and with varying degrees of interaction between the V2X wireless devices UEs (user equipment) and the NW (network), including support for standalone, network-less operation.

LTE V2X mainly targets basic road safety use cases like forward collision warning, emergency braking, roadworks warning, etc. Vehicle V2X wireless device UEs supporting V2X applications can exchange their own status information such as position, speed and heading, with other nearby vehicles, infrastructure nodes and/or pedestrians. Types of messages sent by the vehicles include Co-operative Awareness Messages (CAMs) and Decentralized Environmental Notification Messages (DENMs), defined by ETSI (European Telecommunications Standards Institute), or Basic Safety Messages (BSMs), defined by the SAE (Society of the Automotive Engineers).

3GPP has started a new study item (SI) in August 2018 within the scope of Rel-16 to develop a new radio (NR) version of V2X communications. The NR V2X will mainly target advanced V2X services, which can be categorized into four use case groups: vehicles platooning, extended sensors, advanced driving and remote driving. The advanced V2X services may require enhanced NR systems and a new NR sidelink to meet stringent requirements in terms of latency and reliability. NR V2X system are also expected to have higher system capacity and better coverage and to allow for easy extension to support the future development of further advanced V2X services and other services.

Broadcast/multicast/unicast transmissions in V2X are discussed below.

Due to the nature of the basic road safety services, technical solutions for LTE V2X Rel-14/15 are designed mainly for broadcast transmissions. That means that the intended receiver of each message may be all V2X wireless devices UEs within a relevant distance from the transmitter. In physical layer broadcast communications, the transmitter, in fact, may not have the notion of intended receivers.

Given the targeted services of NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that are only of interest to the members of the platoon, making the members of the platoon a natural groupcast. In another example, the see-through use case most likely involves only a pair of vehicles, for which unicast transmissions may naturally fit.

With such V2X groupcast messages, conventional acknowledgements (ACK/NACK) may consume increased radio resources.

### SUMMARY

According to some embodiments of inventive concepts, a method is provided to operate a first wireless device associated with a group including the first wireless device and a second wireless device. A data packet is received from the second wireless device of the group. A reference signal received power RSRP is measured based on a reference signal received from the second wireless device of the group. It is determined whether or not to transmit Acknowledgement/Negative ACK/NACK feedback for the data packet based on a comparison between the RSRP and an RSRP threshold.

According to some other embodiments of inventive concepts, a first wireless device includes a processor and memory coupled with the processor. The memory includes instructions that when executed by the processor causes the first wireless device to: receive a data packet from a second wireless device of a group, wherein the group includes the first wireless device and the second wireless device; measure a reference signal received power RSRP based on a reference signal received from the second wireless device of the group; and determine whether or not to transmit Acknowledgement/Negative ACK/NACK feedback for the data packet based on a comparison between the RSRP and an RSRP threshold.

According to still other embodiments of inventive concepts, a first wireless device is adapted to receive a data packet from a second wireless device of a group, wherein the group includes the first wireless device and the second wireless device. The first wireless device is further adapted to measure a reference signal received power RSRP based on a reference signal received from the second wireless device of the group. The first wireless device is still further adapted to determine whether or not to transmit Acknowledgement/Negative ACK/NACK feedback for the data packet based on a comparison between the RSRP and an RSRP threshold.

According to further embodiments of inventive concepts, a computer program includes program code to be executed by at least one processor of a first wireless device. Execution of the program code causes the first wireless device to: receive a data packet from a second wireless device of a group, wherein the group includes the first wireless device and the second wireless device; measure a reference signal received power RSRP based on a reference signal received from the second wireless device of the group; and determine whether or not to transmit Acknowledgement/Negative ACK/NACK feedback for the data packet based on a comparison between the RSRP and an RSRP threshold.

According to still further embodiments of inventive concepts, a computer program product includes a non-transitory storage medium including program code to be executed by at least one processor of a first wireless device. Execution of the program code causes the first wireless device to: receive a data packet from a second wireless device of a group, wherein the group includes the first wireless device and the second wireless device; measure a reference signal received power RSRP based on a reference signal received from the second wireless device of the group; and determine whether or not to transmit Acknowledgement/Negative ACK/NACK feedback for the data packet based on a comparison between the RSRP and an RSRP threshold.

According to some embodiments, unnecessary ACK/NACK retransmissions may be reduced thereby reducing sidelink/network congestion.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 is a schematic diagram illustrating V2X (Vehicle-to-Anything) communication scenarios in an LTE/NR base network;

FIG. 2 is a block diagram illustrating a wireless communication device UE according to some embodiments of inventive concepts;

FIG. 3 is a block diagram illustrating a network node according to some embodiments of inventive concepts;

FIGS. 4 and 5 are flow charts illustrating operations of wireless devices (also referred to as wireless communication devices, UEs, etc.) according to some embodiments of inventive concepts;

FIG. 6 is a block diagram of a wireless network in accordance with some embodiments;

FIG. 7 is a block diagram of a user equipment in accordance with some embodiments

FIG. 8 is a block diagram of a virtualization environment in accordance with some embodiments;

FIG. 9 is a block diagram of a telecommunication network connected via an intermediate network to a host computer in accordance with some embodiments;

FIG. 10 is a block diagram of a host computer communicating via a base station with a user equipment over a partially wireless connection in accordance with some embodiments;

FIG. 11 is a block diagram of methods implemented in a communication system including a host computer, a base station and a user equipment in accordance with some embodiments;

FIG. 12 is a block diagram of methods implemented in a communication system including a host computer, a base station and a user equipment in accordance with some embodiments;

FIG. 13 is a block diagram of methods implemented in a communication system including a host computer, a base station and a user equipment in accordance with some embodiments;

FIG. 14 is a block diagram of methods implemented in a communication system including a host computer, a base station and a user equipment in accordance with some embodiments;

FIG. 15 illustrates CSI report transmission using PSSCH in accordance with some embodiments;

FIG. 16 illustrates independent resource selections of CSI report and data in accordance with some embodiments; and

FIG. 17 illustrates a slot structure containing SCSI-RS in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

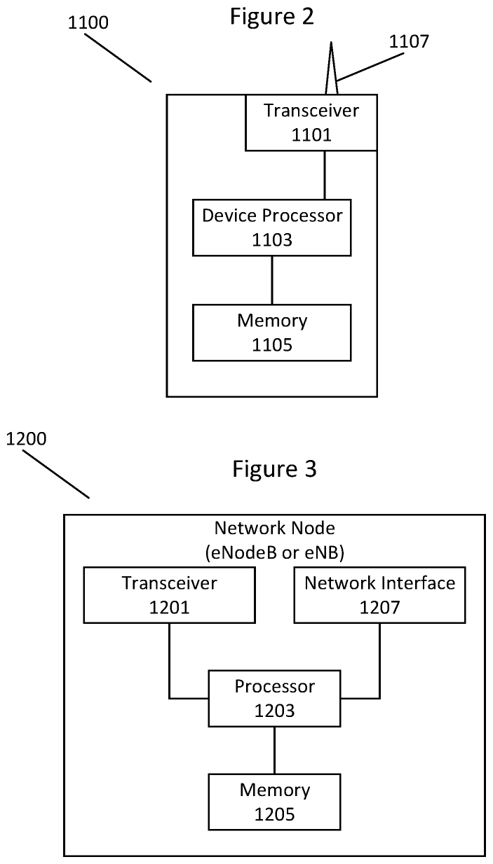

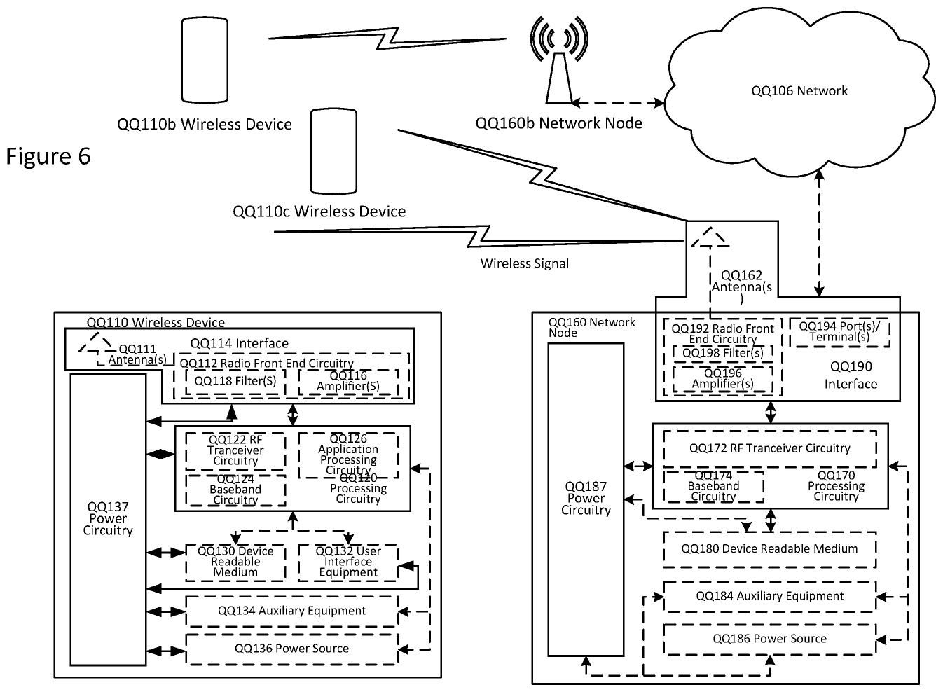

FIG. 2 is a block diagram illustrating elements of a V2X wireless device UE 1100 (also referred to as a wireless communication device, a wireless terminal, a wireless communication terminal, user equipment, UE, or a user equipment node/terminal/device) configured to provide V2X sidelink communication according to embodiments of inventive concepts. (V2X wireless device 1100 may be provided, for example, as discussed below with respect to wireless device QQ110 of FIG. 6.) As shown, wireless communication device UE 1100 may include a transceiver circuit 1101 (also referred to as a transceiver, e.g., corresponding to interface QQ114 of FIG. 6) including a transmitter and a receiver configured to provide uplink and downlink radio communications with a base station of a radio access network, and to provide V2X sidelink communications (e.g., V2V and/or V2P communications) directly with other V2X wireless communication devices. Wireless communication device UE 1100 may also include a processor circuit 1103 (also referred to as a processor or processing circuitry, e.g., corresponding to processing circuitry QQ120 of FIG. 6) coupled to the transceiver circuit, and a memory circuit 1105 (also referred to as memory, e.g., corresponding to device readable medium QQ130 of FIG. 6) coupled to the processor circuit. The memory circuit 1105 may include computer readable program code that when executed by the processor circuit 1103 causes the processor circuit to perform operations according to embodiments disclosed herein. According to other embodiments, processor circuit 1103 may be defined to include memory so that a separate memory circuit is not required. Wireless communication device UE may also include an interface (such as a user interface) coupled with processor 1103, and/or wireless communication device UE may be incorporated in a vehicle.

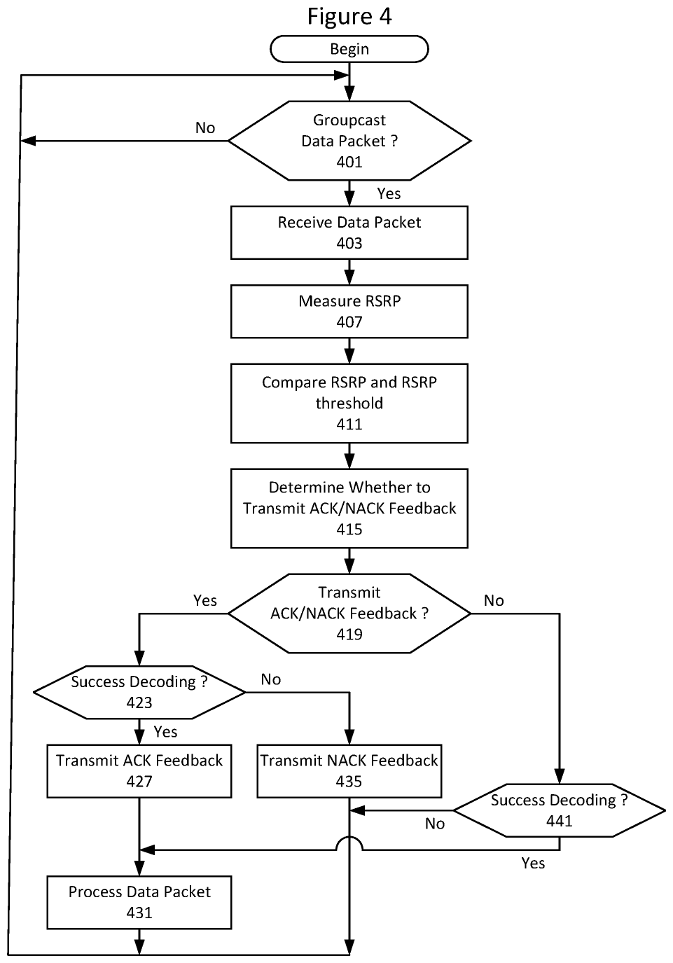

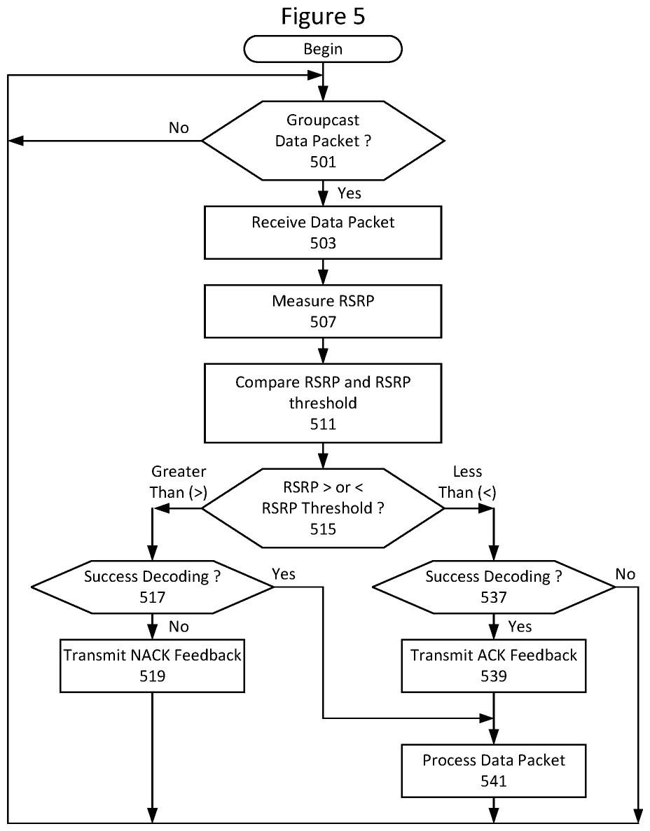

As discussed herein, operations of wireless communication device UE 1100 may be performed by processor 1103 and/or transceiver 1101. For example, processor 1103 may control transceiver 1101 to transmit communications through transceiver 1101 over a radio interface to another UE and/or to receive communications through transceiver 1101 from another UE over a radio interface. In addition, processor 1103 may control transceiver 1101 to receive communications through transceiver 1101 from Radio Access Network base station (e.g., an eNodeB/eNB or gNodeB/gNB). Moreover, modules may be stored in memory 1105, and these modules may provide instructions so that when instructions of a module are executed by processor 1103, processor 1103 performs respective operations (e.g., operations discussed below with respect to the Example Embodiments and/or one or more of FIGS. 4-5).

FIG. 3 is a block diagram illustrating elements of a node (also referred to as a network node, base station, eNB, eNodeB, gNB, gNodeB, etc.) of a Radio Access Network (RAN) configured to provide cellular communication according to embodiments of inventive concepts. As shown, the network node may include a transceiver circuit 1201 (also referred to as a transceiver) including a transmitter and a receiver configured to provide uplink and downlink radio communications with wireless communication devices UEs. The network node may include a network interface circuit 1207 (also referred to as a network interface) configured to provide communications with other nodes (e.g., with other base stations and/or core network nodes) of the RAN and/or core network. The network node may also include a processor circuit 1203 (also referred to as a processor) coupled to the transceiver circuit, and a memory circuit 1205 (also referred to as memory) coupled to the processor circuit. The memory circuit 1205 may include computer readable program code that when executed by the processor circuit 1203 causes the processor circuit to perform operations according to embodiments disclosed herein. According to other embodiments, processor circuit 1203 may be defined to include memory so that a separate memory circuit is not required.

As discussed herein, operations of the network node may be performed by processor 1203, network interface 1207, and/or transceiver 1201. For example, processor 1203 may control transceiver 1201 to transmit communications through transceiver 1201 over a radio interface to one or more UEs and/or to receive communications through transceiver 1201 from one or more UEs over a radio interface. Similarly, processor 1203 may control network interface 1207 to transmit communications through network interface 1207 to one or more other network nodes and/or to receive communications through network interface from one or more other network nodes. Moreover, modules may be stored in memory 1205, and these modules may provide instructions so that when instructions of a module are executed by processor 1203, processor 1203 performs respective operations.

For a broadcast transmission, no feedback from the receivers to the transmitter may be required. Indeed, feedback for broadcast transmissions may even be undesirable since it can quickly congest the network. This is not the case for groupcast or unicast transmissions because such transmissions often aim at a limited number of receivers with potentially some expected level of reliability and/or data rate. As a result, certain mechanisms for feedback and retransmission, such as the Hybrid Automatic Repeat Request HARQ scheme, may be both feasible and/or useful/necessary for unicast and groupcast.

There are two main methods of performing groupcast, i.e., sending a common message to a group of receivers:
Method 1: the sender V2X wireless device UE of the message forms multiple unicast connections, one to each individual V2X wireless device UE in the group and sends the message over these unicast connections. This is often called groupcast by multiple unicast.
Method 2: the group of V2X wireless devices UEs share a common group ID, the sender V2X wireless device UE sends the message to all other V2X wireless devices UEs at once, using that group ID.

Method 1 may be more complex than method 2, since it does not leverage the fact that the message is common for the whole group. In the worst case—where every V2X wireless device UE groupcasts a message—the number of unicast connections scales with the square of the number of V2X wireless devices UEs. For the same reason, method 1 may also consume more radio resources, both for transmitting messages and for sending feedbacks. Method 2, on the other hand, can allow for ways of disseminating messages and obtaining feedback in the group. One feedback and retransmission scheme for groupcast being proposed in 3GPP works as follows:
All members in a groupcast session, such as vehicles in a platoon, share a common group ID used for their groupcast communication. This can be done, for example, in a group discovery process or by preconfiguration, which are outside the scope of the current disclosure.
Each time a V2X wireless device UE wants to send a message to the other V2X wireless devices UEs in the group, it embeds or scrambles the group ID with a packet carrying the message.
Depending on the outcome of the decoding of the packet, each receiver V2X wireless device UE in the group sends an ACK or a NACK (either implicitly or explicitly, which is outside the scope of the present disclosure). The ACK or the NACK also utilizes the group ID, no individual UE ID in the ACK or NACK message is needed.
When the transmitter V2X wireless device UE receives a NACK (or equivalently not receiving ACKs from all the receiver V2X wireless devices UEs), it performs a retransmission of the packet (for example, resending the same packet or a redundancy version of the packet).

State-of-the-art groupcast protocols described above may only require a common group ID for the whole group and the decision for retransmission may be relatively simple. However, the protocol comes with a potential problem: The transmitter may end up retransmitting unnecessarily a packet many times, and as a result the receivers may need to send ACK/NACK feedbacks many times, leading to inefficient use of radio resources. Two typical scenarios related to the above problem are as follows:
Scenario 1: When one or few of the receivers happen to be in very bad propagation condition, e.g., be blocked by a big truck for a while, then those receivers will keep sending NACKs or no ACKs will be received from them. Consequently, the transmitter retransmits the packet again and again, and other receivers keep sending their ACK/NACK although they have received the packet correctly.
Scenario 2: It can happen that in different (re)transmission attempts of the same packet, different receivers fail to receive the packet. Since only the group ID is used for the ACK/NACK, the transmitter of the packet will not be able to identify which of the receivers have failed to receive the packet (the transmitter only knows that there are some receivers who failed to receive). Consequently, the transmitter keeps retransmitting the packet unnecessarily.

Issues noted above may need to be addressed for the groupcast protocol to be more efficient and/or effective.

According to some embodiments of inventive concepts, methods may be defined by a set of different rules to reduce/limit feedback transmissions in sidelink groupcast. For example, a set of rules may be applied at the V2X wireless device UE that transmits ACK/NACK feedback (i.e., the V2X wireless device UE that receives a data packet) to send the ACK/NACK only when useful/necessary.

Some embodiments of inventive concepts may provide a mechanism to balance between reduced complexity and cost in terms of resource use for groupcast in V2X communications. This may help to improve/optimize benefits of groupcast for sidelink V2X.

To reduce/limit inefficient use of radio resources due to excessive retransmissions of the same packet and/or excessive use of resources used to send HARQ ACK/NACK feedback, certain rules on when and how the HARQ ACK/NACK feedback transmission should take place may be provided. In the following disclosure, rules are described which can be applied individually or collectively when appropriate.

HARQ ACK/NACK feedback transmitted from a V2X wireless device that received a data packet could be in the form of either ACK (Acknowledgement) in case the packet is decoded successfully or NACK (Negative Acknowledgement) in case the packet is not decoded successfully.

In embodiments disclosed below, it is assumed that the receiver V2X wireless device UE of a data packet measures the Reference Signal Received Power (RSRP) using a reference signal (RS) transmitted from the transmitter V2X wireless device UE. Generally, the RSRP is an indication of the channel gain (or loss) between the transmitter and the receiver V2X wireless device UEs (of the data packet), which in turn has some correlation with the physical distance between the transmitter and the receiver. Some disclosed embodiments may use such relations to reduce a number of HARQ ACK/NACK feedbacks sent in the network.

Embodiments of rules to be applied at the V2X wireless device UE transmitting the ACK/NACK feedback (i.e. the receiver V2X wireless device UE of a data packet) are discussed below.

According to a some embodiments of inventive concepts, a V2X wireless device UE determines whether or not to send HARQ ACK/NACK feedback based on comparing the RSRP with a certain RSRP threshold. For example, if the RSRP is below a certain threshold, the V2X wireless device UE sends HARQ ACK/NACK feedback, and if the RSRP is above the threshold, the V2X wireless device UE does not send HARQ ACK/NACK feedback. In another example, if the RSRP is below a certain threshold, the V2X wireless device UE does not send HARQ feedback, and if the RSRP is above the threshold, the V2X wireless device UE sends HARQ feedback.
According to a sub-embodiment, a V2X wireless device UE transmits HARQ ACK/NACK feedback (either ACK or NACK based on the outcome of data decoding) based on criteria defined using both the RSRP and the physical distance from the V2X wireless device UE to the transmitter UE that transmitted the packet. In one example, the V2X wireless device UE decides not to transmit any HARQ feedback (i.e., neither NACK nor ACK) if the RSRP is below a threshold and the distance to the transmitter V2X wireless device UE is greater than the communication range requirement of the packet. In another example, the V2X wireless device UE decides not to transmit any HARQ feedback (i.e., neither NACK nor ACK) if either the RSRP is below a threshold or the distance to the transmitter V2X wireless device UE is greater than the communication range requirement of the packet.
According to another sub-embodiment, a network may (pre-)configure the criteria to be used by the V2X wireless device UE to decide if HARQ ACK/NACK feedback could be transmitted. For instance, depending on the communication scenarios and/or use cases, (pre-)configuration may allow either RSRP-based criteria or distance-based criteria or both RSRP-based and distance-based criteria.
According to another sub-embodiment, the distance between transmitter and receiver V2X wireless devices UEs can be determined/calculated based on their Global Positioning System GPS location or equivalent derived from an actual GPS location. Similarly, the distance between the transmitter and receiver V2X wireless devices UEs can be calculated based on certain identifiers IDs such as zone ID or any other local ID which is assigned according to the actual position during the connection establishment phase.

According to some other embodiments of inventive concepts, a V2X wireless device UE may only send HARQ ACK if the RSRP is below a first threshold (e.g., threshold A) and only send HARQ NACK if the RSRP is above a second threshold (threshold B). For example, a V2X wireless device UE further away from the transmitter V2X wireless device UE may likely have a lower RSRP value and it may be more likely that the V2X wireless device UE will not decode the data packet correctly. Therefore, it may be more meaningful/relevant for the V2X wireless device UE to transmit only HARQ ACK (which happens when the V2X wireless device UE decodes the data packet successfully). Conversely, a V2X wireless device UE closer to the transmitter V2X wireless device UE will likely have a higher RSRP value and it is more likely that the V2X wireless device UE will decode the data packet correctly. Therefore, transmitting only HARQ NACK (when the data decoding fails) may be more meaningful/relevant.
According to a sub-embodiment, threshold A and threshold B used in the above embodiment may be the same.
According to another sub-embodiment, a network may (pre-)configure the criteria to be used by the V2X wireless device UE to decide whether only HARQ ACK or only HARQ NACK or both could/should be transmitted. For example, for some scenarios and/or use cases, (pre-)configuration may allow only HARQ ACK transmissions if RSRP is below a threshold and only HARQ NACK transmissions if RSRP is above a threshold. Whereas, for some other scenarios, (pre-)configuration may allow only HARQ ACK transmissions if RSRP is above the threshold and only HARQ NACK transmissions if RSRP is below a threshold.

In some embodiments, the RSRP threshold(s) as described in the above embodiments may be defined as a function of Quality of Service QoS parameters such as reliability or latency. For example, a service with a higher reliability requirement, may define a lower RSRP threshold(s) and a service with a lower reliability requirement may define a higher RSRP threshold(s).

In some embodiments, the RSRP threshold(s) as described in above embodiments may be defined as a function of a communication range requirement of a service. For example, a service with higher communication range requirement may define a lower RSRP threshold(s), and a service with lower communication range requirement may define a higher RSRP threshold(s).

In some embodiments, the RSRP threshold(s) as described in above embodiments may be defined as a function of channel congestion level, e.g., Channel Busy Ratio CBR. For example, a higher channel congestion level may yield a higher RSRP threshold(s), if the V2X wireless device UE only sends HARQ ACK/NACK feedback when RSRP measurement is higher than the RSRP threshold. Similarly, a lower channel congestion level may yield a lower RSRP threshold(s), if the V2X wireless device UE only sends HARQ ACK/NACK feedback when RSRP measurement is higher than the RSRP threshold.

In some embodiments, the RSRP thresholds as described in above embodiments may be defined as a function of all the three factors: communication range requirement, QoS requirement of a service, and/or the channel congestion level; or a combination of any two factors among them.

Embodiments regarding RSRP measurements are discussed below.

In some embodiments, the RSRP may be measured on any kind of reference signal(s) used over sidelink such as Channel State Information Reference Signal CSI-RS, Sounding Reference Signal SRS, and/or Demodulation Reference Signal DMRS, or is a combination of measurements on one or more of these reference signals.
In some embodiments, RSRP may be measured on the DMRS of the Physical Sidelink Control Channel (PSCCH). An advantage of using the DMRS may be that the PSCCH is typically not pre-coded or beamformed and is transmitted using a more robust modulation and coding scheme (MCS) than the Physical Sidelink Shared Channel (PSSCH). Therefore, the RSRP measured on the PSCCH may be a good indicator of the channel gain (or loss) between the transmitter and the receiver. For the same reason, the RSRP can be measured on the CSI-RS.
In other embodiments, RSRP may be measured on the DMRS of the Physical Sidelink Shared Channel (PSSCH).

In some embodiments, the receiver V2X wireless device UE may already know the transmission power used by the transmitter V2X wireless device UE. For example, the transmission power in the case of a groupcast can be (pre-)configured. This may enable the receiver V2X wireless device UE to estimate the channel gain (or loss) based on the RSRP.

In still other embodiments, the receiver V2X wireless device UE may estimate the transmission power used by the transmitter V2X wireless device UE based on the communication range requirement of the particular service. For example, the receiver V2X wireless device UE may use the same power control formula as that of the transmitter V2X wireless device UE to estimate the transmission power being used by the other V2X wireless device UE.

Some embodiments of inventive concepts may thus reduce/avoid resending a packet again and again in groupcast while only a small portion of the V2X wireless devices UEs in the group fail to receive the packet in the initial transmission and/or in retransmissions. Unnecessary retransmissions may thus be reduced according to some embodiments of inventive concepts.

Operations of a V2X wireless communication device 1100 will now be discussed with reference to the flow chart of FIG. 4 according to some embodiments of inventive concepts. For example, modules may be stored in memory 1105 of FIG. 2, and these modules may provide instructions so that when the instructions of a module are executed by wireless communication device processor 1103, processor 1103 performs respective operations of the flow chart of FIG. 4.

Responsive to a groupcast data packet (transmitted from a second V2X wireless device) at block 401, processor 1103 may receive the data packet (through transceiver 1101) from the second V2X wireless device of the group at block 403. At block 407, processor 1103 may measure a reference signal received power RSRP based on a reference signal received from the second V2X wireless device of the group. At block 411, processor 1103 may compare the RSRP measured at block 407 with an RSRP threshold.

At blocks 415 and 419, processor 1103 may determine whether or not to transmit Acknowledgement/Negative ACK/NACK feedback for the data packet based on the comparison between the RSRP and an RSRP threshold at block 411. According to some embodiments, processor 1103 may determine to transmit ACK/NACK feedback responsive to the RSRP being less than the RSRP threshold, and/or processor 1103 may determine to not transmit ACK/NACK feedback responsive to the RSRP being greater than the RSRP threshold.

When the measured RSRP is less than the RSRP threshold at block 411, processor 1103 may determine at blocks 415 and 419 to transmit ACK/NACK feedback (following the “Yes” output of block 419) based on the RSRP being less than the RSRP threshold. In this case, if the data packet is successfully decoded at block 423, processor 1103 may transmit ACK feedback for the data packet at block 427 responsive to success decoding the data packet, and processor 1103 processes the data packet at block 431 responsive to success decoding the data packet. In this case, if the data packet is not successfully decoded at block 423, processor 1103 may transmit NACK feedback for the data packet responsive to failure decoding the data packet at block 435 without processing the data packet.

When the measured RSRP is greater than the RSRP threshold at block 411, processor 1103 may determine at blocks 415 and 419 to not transmit ACK/NACK feedback (following the “No” output of block 419) based on the RSRP being greater than the RSRP threshold. In this case, if the data packet is successfully decoded at block 441, processor 1103 may process the data packet at block 431 responsive to success decoding the data packet without transmitting ACK feedback. In this case, if the data packet is not successfully decoded at block at block 441, processor 1103 may neither process the data packet nor transmit NACK feedback for the data packet.

The RSRP threshold of FIG. 4 may be determined at the first V2X wireless device based on a known transmission power used by the second V2X wireless device to transmit the reference signal, and/or based on an estimate of transmission power used by the second V2X wireless device to transmit the reference signal. In addition, measuring the RSRP at block 407 may include measuring the RSRP using at least one of a demodulation reference signal DMRS, a sounding reference signal SRS, and/or a channel state information reference signal CSI-RS. Moreover, the RSRP threshold may be determined by the first V2X wireless device based on at least one of a quality of service QoS, parameter associated with the group, a communication range requirement of a service associated with the group, and/or a channel congestion level.

Each groupcast data packet of the group from one or more other V2X wireless devices of the group may thus be handled in accordance with the operations illustrated in FIG. 4 as discussed above. For example, a first data packet from the second V2X wireless device of the group may be processed through blocks 419, 423, 427 (transmitting ACK feedback for the first data packet), and 431 (processing the first data packet) responsive to a corresponding first RSRP measured at block 411 being less than the RSRP threshold and responsive to success decoding the first data packet. A second data packet from the second (or another) V2X wireless device of the group may be processed through blocks 419, 423, and 435 (transmitting NACK feedback for the second data packet without processing the second data packet) responsive to a corresponding second RSRP measured at block 411 being less than the RSRP threshold and responsive to failure decoding the second data packet. A third data packet from the second (or another) V2X wireless device of the group may be processed through blocks 419, 441, and 431 (processing the third data packet without transmitting ACK feedback for the third data packet) responsive to a corresponding third RSRP measured at block 411 being greater than the RSRP threshold and responsive to success decoding the third data packet. A fourth data packet from the second (or another) V2X wireless device of the group may be processed through blocks 419 and 441 (without processing the fourth data packet and without transmitting NACK feedback) responsive to a corresponding fourth RSRP measured at block 411 being greater than the RSRP threshold and responsive to failure decoding the fourth data packet. While the data packets are named first, second, third, and fourth data packets, the terms first, second, third, and fourth are used to distinguish the different data packets without implying an order in time.

According to embodiments discussed above, whether to transmit ACK/NACK feedback may be determined based on the RSRP measured for a data packet being less/greater than an RSRP threshold. According to some other embodiments, processor 1103 may determine to transmit ACK/NACK feedback responsive to the RSRP being less than the RSRP threshold or responsive to a distance between the first and second V2X wireless devices being greater than a distance threshold (resulting in operations following the “Yes” output of block 419), or processor 1103 may determine to not transmit ACK/NACK feedback responsive to the RSRP being greater than the RSRP threshold and responsive to a distance between the first and second V2X wireless devices being less than the distance threshold (resulting in operations following the “No” output of block 419). In such embodiments, the distance threshold may be determined based on a communication range requirement of the data packet, and/or based on a configuration received from a radio access network. Moreover, the distance between the first and second wireless devices may be derived based on global positioning system GPS information for the first wireless device, based on GPS information received from the second wireless device, based on an area identifier for the first wireless device assigned by a radio access network, and/or based on an area identifier for the second wireless device received from the second wireless device.

Various operations from the flow chart of FIG. 4 may be optional with respect to some embodiments of wireless communication devices and related methods. Regarding methods of some embodiments, for example, operations of blocks 401, 411, 415, 423, 427, 431, 435, and 441 of FIG. 4 may be optional.

Operations of a V2X wireless communication device 1100 will now be discussed with reference to the flow chart of FIG. 4 according to some other embodiments of inventive concepts. For example, modules may be stored in memory 1105 of FIG. 2, and these modules may provide instructions so that when the instructions of a module are executed by wireless communication device processor 1103, processor 1103 performs respective operations of the flow chart of FIG. 4.

Responsive to a groupcast data packet (transmitted from a second V2X wireless device) at block 401, processor 1103 may receive the data packet (through transceiver 1101) from the second V2X wireless device of the group at block 403. At block 407, processor 1103 may measure a reference signal received power RSRP based on a reference signal received from the second V2X wireless device of the group. At block 411, processor 1103 may compare the RSRP measured at block 407 with an RSRP threshold.

At blocks 415 and 419, processor 1103 may determine whether or not to transmit Acknowledgement/Negative ACK/NACK feedback for the data packet based on the comparison between the RSRP and an RSRP threshold at block 411. According to some embodiments, processor 1103 may determine to transmit ACK/NACK feedback responsive to the RSRP being greater than the RSRP threshold, and/or processor may determine to not transmit ACK/NACK feedback responsive to the RSRP being less than the RSRP threshold.

When the measured RSRP is greater than the RSRP threshold at block 411, processor 1103 may determine at blocks 415 and 419 to transmit ACK/NACK feedback (following the “Yes” output of block 419) based on the RSRP being greater than the RSRP threshold. In this case, if the data packet is successfully decoded at block 423, processor 1103 may transmit ACK feedback for the data packet at block 427 responsive to success decoding the data packet. In this case, if the data packet is not successfully decoded at block 423, processor 1103 may transmit NACK feedback for the data packet responsive to failure decoding the data packet at block 435 without processing the data packet.

When the measured RSRP is less than the RSRP threshold at block 411, processor 1103 may determine at blocks 415 and 419 to not transmit ACK/NACK feedback (following the “No” output of block 419) based on the RSRP being less than the RSRP threshold. In this case, if the data packet is successfully decoded at block 411, processor 1103 process the data packet at block 431 responsive to success decoding the data packet without transmitting ACK feedback. In this case, if the data packet is not successfully decoded at block 441, processor 1103 may neither process the data packet nor transmit NACK feedback for the data packet.

The RSRP threshold of FIG. 4 may be determined at the first V2X wireless device based on a known transmission power used by the second V2X wireless device to transmit the reference signal, and/or based on an estimate of transmission power used by the second V2X wireless device to transmit the reference signal. In addition, measuring the RSRP at block 407 may include measuring the RSRP using at least one of a demodulation reference signal DMRS, a sounding reference signal SRS, and/or a channel state information reference signal CSI-RS. Moreover, the RSRP threshold may be determined by the first V2X wireless device based on at least one of a quality of service QoS, parameter associated with the group, a communication range requirement of a service associated with the group, and/or a channel congestion level.

Each groupcast data packet of the group from one or more other V2X wireless devices of the group may thus be handled in accordance with the operations illustrated in FIG. 4 as discussed above. For example, a first data packet from the second V2X wireless device of the group may be processed through blocks 419, 423, 427 (transmitting ACK feedback for the first data packet), and 431 (processing the first data packet) responsive to a corresponding first RSRP measured at block 411 being greater than the RSRP threshold and responsive to success decoding the first data packet. A second data packet from the second (or another) V2X wireless device of the group may be processed through blocks 419, 423, and 435 (transmitting NACK feedback for the second data packet without processing the second data packet) responsive to a corresponding second RSRP measured at block 411 being greater than the RSRP threshold and responsive to failure decoding the second data packet. A third data packet from the second (or another) V2X wireless device of the group may be processed through blocks 419, 441, and 431 (processing the third data packet without transmitting ACK feedback for the third data packet) responsive to a corresponding third RSRP measured at block 411 being less than the RSRP threshold and responsive to success decoding the third data packet. A fourth data packet from the second (or another) V2X wireless device of the group may be processed through blocks 419 and 441 (without processing the fourth data packet and without transmitting NACK feedback) responsive to a corresponding fourth RSRP measured at block 411 being less than the RSRP threshold and responsive to failure decoding the fourth data packet. While the data packets are named first, second, third, and fourth data packets, the terms first, second, third, and fourth are used to distinguish the different data packets without implying an order in time.

According to embodiments discussed above, whether to transmit ACK/NACK feedback may be determined based on the RSRP measured for a data packet being greater/less than an RSRP threshold. According to some other embodiments, processor 1103 may determine to transmit ACK/NACK feedback responsive to the RSRP being greater than the RSRP threshold or responsive to a distance between the first and second V2X wireless devices being less than a distance threshold (resulting in operations following the “Yes” output of block 419), or processor 1103 may determine to not transmit ACK/NACK feedback responsive to the RSRP being less than the RSRP threshold and responsive to a distance between the first and second V2X wireless devices being greater than the distance threshold (resulting in operations following the “No” output of block 419). In such embodiments, the distance threshold may be determined based on a communication range requirement of the data packet, and/or based on a configuration received from a radio access network. Moreover, the distance between the first and second wireless devices may be derived based on global positioning system GPS information for the first wireless device, based on GPS information received from the second wireless device, based on an area identifier for the first wireless device assigned by a radio access network, and/or based on an area identifier for the second wireless device received from the second wireless device.

Various operations from the flow chart of FIG. 4 may be optional with respect to some embodiments of wireless communication devices and related methods. Regarding methods of some embodiments, for example, operations of blocks 401, 411, 415, 423, 427, 431, 435, and 441 of FIG. 4 may be optional.

Operations of a V2X wireless communication device 1100 will now be discussed with reference to the flow chart of FIG. 5 according to still other embodiments of inventive concepts. For example, modules may be stored in memory 1105 of FIG. 2, and these modules may provide instructions so that when the instructions of a module are executed by wireless communication device processor 1103, processor 1103 performs respective operations of the flow chart of FIG. 5.

Responsive to a groupcast data packet (transmitted from a second V2X wireless device) at block 501, processor 1103 may receive the data packet (through transceiver 1101) from the second V2X wireless device of the group at block 503. At block 507, processor 1103 may measure a reference signal received power RSRP based on a reference signal received from the second V2X wireless device of the group. At block 511, processor 1103 may compare the RSRP measured at block 507 with an RSRP threshold. At blocks 515, 517, and 519, processor 1103 may determine whether or not to transmit Acknowledgement/Negative ACK/NACK feedback for the data packet based on the comparison between the RSRP and an RSRP threshold at block 511.

If the RSRP measured at block 511 is greater than the RSRP threshold at block 515, processor 1103 may determine to not transmit ACK feedback responsive to the RSRP being greater than the RSRP threshold and responsive to successfully decoding the data packet at block 517. If the RSRP is greater than the RSRP threshold, processor 1103 may process the data packet at block 541 (without transmitting ACK feedback for the data packet) responsive to the RSRP being greater than the RSRP threshold and responsive to successfully decoding the data packet. Moreover, processor 1103 may determine to transmit NACK feedback responsive to the RSRP being greater than the RSRP threshold and responsive to failure decoding the data packet at block 517. If the RSRP is greater than the RSRP threshold, processor 1103 may transmit NACK feedback for the data packet at block 519 (without processing the data packet) responsive to the RSRP being greater than the RSRP threshold and responsive to failure decoding the data packet.

If the RSRP measured at block 511 is less than the RSRP threshold at block 515, processor 1103 may determine to not transmit NACK feedback responsive to the RSRP being less than the RSRP threshold and responsive to failure decoding the data packet at block 537. If the RSRP is less than the RSRP threshold, processor 1103 may determine to transmit ACK feedback at block 539 responsive to the RSRP being less than the RSRP threshold and responsive to success decoding the data packet at block 537. In this case, processor 1103 may transmit ACK feedback for the data packet at block 539 responsive to the RSRP being less than the RSRP threshold and responsive to success decoding the data packet at block 537, and processor 1103 may process the data packet at block 541 responsive to the RSRP being less than the RSRP threshold and responsive to success decoding the data packet.

The RSRP threshold of blocks 511 and 515 may be determined based on a configuration received form a radio access network. Moreover the RSRP threshold of blocks 511 and 515 may be first and second RSRP thresholds such that the first RSRP threshold is used for the greater than “>” decision and the second RSRP threshold is used for the less than “<” decision. In other words, processor 1103 proceeds to block 517 if the RSRP is greater than the first RSRP threshold, processor 1103 proceeds to block 537 if the RSRP is less than the second RSRP threshold, and the first RSRP threshold may be greater than the second RSRP threshold. According to some other embodiments, the first and second RSRP thresholds may be the same.

Each groupcast data packet of the group from one or more other V2X wireless devices of the group may thus be handled in accordance with the operations illustrated in FIG. 5 as discussed above. For example, a first data packet from the second V2X wireless device of the group may be processed through blocks 515, 537, 539 (transmitting ACK feedback for the first data packet), and 541 (processing the first data packet) responsive to a corresponding first RSRP measured at block 511 being less than the RSRP threshold at block 515 and responsive to success decoding the first data packet at block 537. A second data packet from the second (or another) V2X wireless device of the group may be processed through blocks 515, 517, and 519 (transmitting NACK feedback for the second data packet without processing the second data packet) responsive to a corresponding second RSRP measured at block 511 being greater than the RSRP threshold at block 515 and responsive to failure decoding the second data packet at block 517. A third data packet from the second (or another) V2X wireless device of the group may be processed through blocks 515, 517, and 541 (processing the third data packet without transmitting ACK feedback for the third data packet) responsive to a corresponding third RSRP measured at block 511 being greater than the RSRP threshold at block 515 and responsive to success decoding the third data packet at block 517. A fourth data packet from the second (or another) V2X wireless device of the group may be processed through blocks 515 and 537 (without processing the fourth data packet and without transmitting NACK feedback) responsive to a corresponding fourth RSRP measured at block 511 being less than the RSRP threshold at block 515 and responsive to failure decoding the fourth data packet at block 537. While the data packets are named first, second, third, and fourth data packets, the terms first, second, third, and fourth are used to distinguish the different data packets without implying an order in time.

The RSRP threshold of FIG. 5 may be determined at the first V2X wireless device based on a known transmission power used by the second V2X wireless device to transmit the reference signal, and/or based on an estimate of transmission power used by the second V2X wireless device to transmit the reference signal. In addition, measuring the RSRP at block 507 may include measuring the RSRP using at least one of a demodulation reference signal DMRS, a sounding reference signal SRS, and/or a channel state information reference signal CSI-RS. Moreover, the RSRP threshold may be determined by the first V2X wireless device based on at least one of a quality of service QoS, parameter associated with the group, a communication range requirement of a service associated with the group, and/or a channel congestion level.

Various operations from the flow chart of FIG. 5 may be optional with respect to some embodiments of wireless communication devices and related methods. Regarding methods of some embodiments, for example, operations of blocks 501, 511, 519, 539, and 541.

The following portions of the present disclosure discuss sidelink physical layer procedures.

A work item description (WID) for NR V2X Rel-16 has been agreed by RAN plenary #83, referred to as Reference [1]. The following portions of the present disclosure discuss the aspects related to sidelink physical layer procedures. In particular, the main topics include: Sidelink HARQ for unicast and groupcast; Sidelink CSI report and sidelink CSI RS; and Open-loop power control.

The study of the unicast and groupcast sidelink V2X communications is included in the SID. It has been agreed that HARQ feedback will be supported for SL unicast and groupcast. Besides, in RAN1 the following agreements related to HARQ feedback were made.

It has been agreed that when SL HARQ feedback is enabled for unicast, the following operation is supported for the non-CBG (Code Block Group) case:
Receiver UE generates HARQ-ACK if it successfully decodes the corresponding TB. It generates HARQ-NACK if it does not successfully decode the corresponding TB after decoding the associated PSCCH which targets the receiver UE.
FFS whether to support SL HARQ feedback per CBG

It has been agreed that when SL HARQ feedback is enabled for groupcast, the following operations are further studied for the non-CBG case:
Option 1: Receiver UE transmits HARQ-NACK on PSFCH if it fails to decode the corresponding TB after decoding the associated PSCCH. It transmits no signal on PSFCH otherwise. Details are FFS including the following:
   Whether to introduce an additional criterion in deciding HARQ-NACK transmission
   Whether/how to handle DTX issue (i.e., transmitter UE cannot recognize the case that a receiver UE misses PSCCH scheduling PSSCH)
   Issues when multiple receiver UEs transmit HARQ-NACK on the same resource
      How to determine the presence of HARQ-NACK transmissions from receiver UEs
      Whether/how to handle destructive channel sum effect of HARQ-NACK transmissions from multiple receiver UEs if the same signal is used
Option 2: Receiver UE transmits HARQ-ACK on PSFCH if it successfully decodes the corresponding TB. It transmits HARQ-NACK on PSFCH if it does not successfully decode the corresponding TB after decoding the associated PSCCH which targets the receiver UE. Details are FFS including the following:
   Whether to introduce an additional criterion in deciding HARQ-ACK/NACK transmission
   How to determine the PSFCH resource used by each receiver UE
FFS whether to support SL HARQ feedback per CBG
Other options are not precluded

It is a working assumption that when HARQ feedback is enabled for groupcast support:
Option 1: Receiver UE transmits only HARQ NACK
Option 2: Receiver UE transmits HARQ ACK/NACK
FFS applicability of option 1 and option 2—this part is particularly relevant to confirm (or not) the working assumption

It has been agreed that it is supported that in mode 1 for unicast, the in-coverage UE sends an indication to gNB to indicate the need for retransmission
At least PUCCH is used to report the information
   If feasible, RAN1 reuses PUCCH defined in Rel-15
The gNB can also schedule re-transmission resource
FFS transmitter UE and/or receiver UE
   If receiver UE, the indication is in the form of HARQ ACK/NAK
   If transmitter UE, FFS

It has been agreed that (Pre-)configuration indicates whether SL HARQ feedback is enabled or disabled in unicast and/or groupcast.
When (pre-)configuration enables SL HARQ feedback, FFS whether SL HARQ feedback is always used or there is additional condition of actually using SL HARQ feedback.

It has been agreed that (Pre-)configuration indicates the time gap between PSFCH and the associated PSSCH for Mode 1 and Mode 2.

It has been agreed that in mode 1 for unicast and groupcast, it is supported for the transmitter UE via Uu link to report an indication to gNB to indicate the need for retransmission of a TB transmitted by the transmitter UE.
FFS the format of the indication, e.g., in the form of HARQ ACK/NACK, or in the form of SR/BSR, etc.

RAN1 continues discussion on whether to support report from the receiver UE
No inter-BS communication will be considered.

It has been agreed that for sidelink groupcast, it is supported to use TX-RX distance and/or RSRP in deciding whether to send HARQ feedback.
Details to be discussed during WI phase, including whether the information on TX-RX distance is explicitly signaled or implicitly derived, whether/how this operation is related to resource allocation, accuracy of distance and/or RSRP, the aspects related to “and/or”, etc.
This feature can be disabled/enabled

In the following portions of the present disclosure, HARQ for sidelink unicast and groupcast is discussed.

NR SL targets uses cases with packet sizes ranging from a few tens of bits to several thousands of bits. For the higher end, CB (Code Block) segmentation is necessarily applied. At the same time, the NR PHY uses a frequency-first mapping of coded bits to resource elements. Given the high time selectivity that characterizes V2X channels, different CBs will experience different channel conditions, better for some worse for others. That is, if different CBs are transmitted over difference coherence intervals, the probability of decoding them correctly will be independent. Such scenario calls for acknowledgment of CBs in groups (i.e., CBGs), avoiding retransmission of large numbers of bits. At the same time, it seems reasonable to limit the utilization of CBG-based feedback to those situations in which it is indeed useful (e.g., for big packet sizes, etc.). Therefore, we believe that the CBG based HARQ feedback can be made configurable, i.e. the network configures UEs operating in-coverage and for out-of-coverage UEs, it can be pre-configured.

A first proposal is that for SL HARQ, CBG-based HARQ feedback is supported and is (pre-)configured.

When it comes to enabling/disabling HARQ feedback, it was agreed to enable or disable HARQ feedback based on (pre-)configuration. Furthermore, HARQ enabling/disabling may also take congestion control and QoS or V2X service requirements in account based on the predefined rules. From signalling perspective, the following two mechanisms may be sufficient:
a) For Mode 1 UEs, the use of HARQ feedback is decided by the gNB (e.g., considering QoS, congestion reports, etc.).
b) For Mode 2 UEs, the UE transmitting the TB/CBG decides whether to request feedback or not based on congestion control and QoS.

A first observation is that for Mode 1 UEs the use of HARQ feedback is configured by the network. For Mode 2 UEs, the transmitter of a TB/CBG decides whether to request feedback.

A second proposal is that congestion and QoS requirements are to be considered to enable or disable HARQ.

Furthermore, the indication to receiver UE needs to be included in SCI if HARQ feedback is enabled or not. For instance, a flag indicating the need of HARQ feedback if turned on. Such indication will also allow other UEs to know the presence of PSFCH in case of sensing based resource allocation (i.e. Mode 2).

A third proposal is that SCI carries a field indicating the presence of corresponding HARQ feedback i.e. ACK/NACK.

It is to be noted that in case of groupcast it may also be possible that the receiver of the TB/CBG decide not to send the HARQ feedback although it is (pre-)configured. The criteria by which RX UE can decide about the transmission of HARQ feedback is either RSRP based and/or distance based. Distance-based HARQ feedback may be a relevant criteria for some scenarios. For instance, UEs physically close to each other but blocked by blocker may have very short radio distance. However, such functionality comes at the cost of additional overhead since position related information needs to be transmitted to the receiver UE. Both RSRP based and distance based HARQ feedback may be supported and can be (pre-)configured. Also, it may happen that a network (pre-)configure a UE to use both RSRP and distance and in this case, a UE may be only allowed to skip HARQ feedback transmission when both criteria are not met.

A fourth proposal is that for sidelink groupcast, both distance and RSRP based HARQ feedback criteria is supported and can be (pre-)configured.

Furthermore, during the SI, a working assumption was made to support both HARQ Option 1 (i.e. only NACK is transmitted) and HARQ Option 2 (i.e. both ACK/NACK is transmitted) for groupcast. The reason to support both the options is their applicability in different scenarios. For instance, there could be two types of groupcast communications: (1) Groupcast with connection establishment, and (2) Groupcast without connection establishment.

For case groupcast with connection establishment, where transmitter and receivers are aware of each other's presence, HARQ Option 2 may be the proper framework for transmission of feedback with the following considerations:
a) There is no additional criterion in deciding transmission of HARQ ACK/NACK. That is, all receivers transmit ACK (or NACK) if they are able (or not) to decode the TB/CBG. Should any further restriction be desirable, then it should be part of the group definition. In other words, if certain UEs are not expected to transmit ACK/NACK, then they should not be part of the group.
b) Resources used for transmission of ACK should be UE-specific. Resources used for transmission of NACK may be UE-specific or group-specific. This allows the receiver of the feedback transmissions to know which UEs correctly received the transmission and/or whether some UE received PSCCH but failed to decode the corresponding TB/CBG.

For groupcast communication without connection establishment i.e. case (2), HARQ Option 1 may be the appropriate framework for HARQ feedback. In this case, the following can be observed:
a) Since there is no connection establishment phase and groups are formed on a transmission-by-transmission basis, it is necessary to restrict the transmission to only NACK messages.
b) DTX issues are not handled in this case. Dealing with such issues may require some sort of connection establishment phase, which is covered in the case discussed before.

HARQ Option 1 may be used on top of HARQ Option 2 for large groups with limited PSFCH resources. In such case, it can happen that a UE joining the group at later point in time may not be able to transmit ACK messages due to unavailable PSFCH resources. Therefore, for such UEs, it is beneficial to only transmit HARQ NACK (i.e., operate with HARQ Option 1 only).

A fifth proposal is to confirm the working assumption of RAN1 #ah-1901 to support both option 1 and option 2 in case of groupcast communication.

For groupcast, having all UEs in the group request HARQ retransmission in case of failed decoded may degrade the performance for all users. Therefore, restrictions on the retransmissions themselves may be considered for both HARQ options. One such criteria is to pre-define thresholds for HARQ ACK or NACK. For instance, a UE retransmits the packet only if total number of HARQ ACKs received are above the threshold.

A second observation is that restrictions on the retransmissions of TB can be applied for both HARQ options for the purpose of congestion control.

Scheduling of HARQ retransmission is discussed below.

In LTE V2X, when selecting a SL resource for the initial transmission, UE selects a SL grant which also contains resources for the HARQ re-transmission. The resources for initial transmission and associated retransmission are then indicated in the SCI, as well as the resource for the next periodic transmission.

The above approach works fine when only blind HARQ retransmissions are supported with no HARQ feedbacks, since the UE can book in advance all the resources for retransmission. However, when HARQ feedbacks are supported, that approach is prone to higher resource consumption since HARQ retransmissions are selected blindly a priori irrespective of any possible HARQ feedback. In fact, whenever an ACK is received, all the HARQ retransmission occasions previously booked are wasted, unless some mechanism to unbook those resources are introduced, which however requires some signalling resources.

A third observation is that if HARQ feedbacks are configured, the LTE approach in which the transmitting UE selects a SL grant reserving resources for both initial transmission and retransmission is prone to high resource consumption, since HARQ retransmissions are selected blindly a priori, irrespective of any possible HARQ feedback.

Therefore, in NR, a more dynamic and adaptive resource allocation scheme for retransmission can be envisioned, i.e. retransmissions are scheduled based on HARQ feedbacks. In mode-1, retransmissions are scheduled by gNB. In mode-2, retransmissions are scheduled autonomously by UE requiring pre-reservation. It seems a more reasonable approach if resources for further retransmissions are booked one by one and indicated in the previous (re)transmission SC. In this way, by using resource booking, the re-transmission can minimize the potential collisions with other UEs, thus improve the transmission reliability, and also limit resource wastage.

A sixth proposal is that for mode-2, if HARQ feedbacks are configured, when selecting a SL resource for the initial transmission, UE reserves resource for one HARQ re-transmission. When a UE decides to retransmit, e.g., receiving a NACK in sidelink unicast, resources for further retransmissions are reserved one by one and indicated in the SCI of previous retransmission. When a UE decides to not retransmit, e.g., receiving an ACK in sidelink unicast, it simply ignores the previously booked retransmission resource.

Sidelink CSI report and sidelink CSI-RS are discussed below. In RAN1 #96, the following working assumptions have been made for CSI acquisition.
For unicast, the following CSI reporting is supported based on non-subband-based aperiodic CSI reporting mechanism assuming no more than 4-port:
   CQI
   RI
   PMI
CSI reporting can be enabled and disabled by configuration.
   It is supported to configure a subset of the above metric for CSI reporting.
There is no standalone RS transmission dedicated to CSI reporting in Rel-16
NR sidelink CSI strives to reuse the CSI framework for NR Uu.
   Discuss details during WI phase
      Furthermore, in WID Reference [1], the following agreements have been made.
Sidelink physical layer procedures as per the study outcome
   CSI acquisition for unicast
      CQI/RI reporting is supported and they are always reported together. No PMI reporting is supported in this work. Multi-rank PSSCH transmission is supported up to two antenna ports.
      In sidelink, CSI is delivered using PSSCH (including PSSCH containing CSI only) using the resource allocation procedure for data transmission.

In this section, details of CSI acquisition for sidelink unicast are discussed, including CSI report and the corresponding sidelink CSI-RS (SCSI-RS).

CSI report parameters are discussed below.

As agreed, non-subband-based RI and CQI reports will be supported for sidelink unicast. In Uu transmissions, typically one RI value and the associated PMI and/or CQI are reported, where RI represents the maximum possible transmission rank of the measured channel. However, this may not be suitable for V2X applications which have diverse service requirements in terms of data rate and reliability. More specifically, some NR eV2X use cases may target high data rate while others target high reliability. Accordingly, to satisfy the diverse requirements, some transmitters are interested in multi-layer transmissions while other transmitters are interested in single layer transmissions. Moreover, the packet size can vary over time as well, where the exact packet size will not be known before the packet arrives. If the time-frequency resource is fixed for a transmission, e.g., via a resource booking, the varied packet size may require different numbers of transmission layers. However, when the receiver reports CSI parameters, it is typically not aware of the transmitter's interest, e.g., the transmission requirement or packet size. In this case, it is beneficial to report multiple RIs and the associated CQI values, which gives the transmitter the flexibility to select more proper transmission parameters based on its own needs.

A seventh proposal is that one sidelink CSI report can include multiple RIs and their respectively associated CQIs.

CSI report scheduling is discussed below.

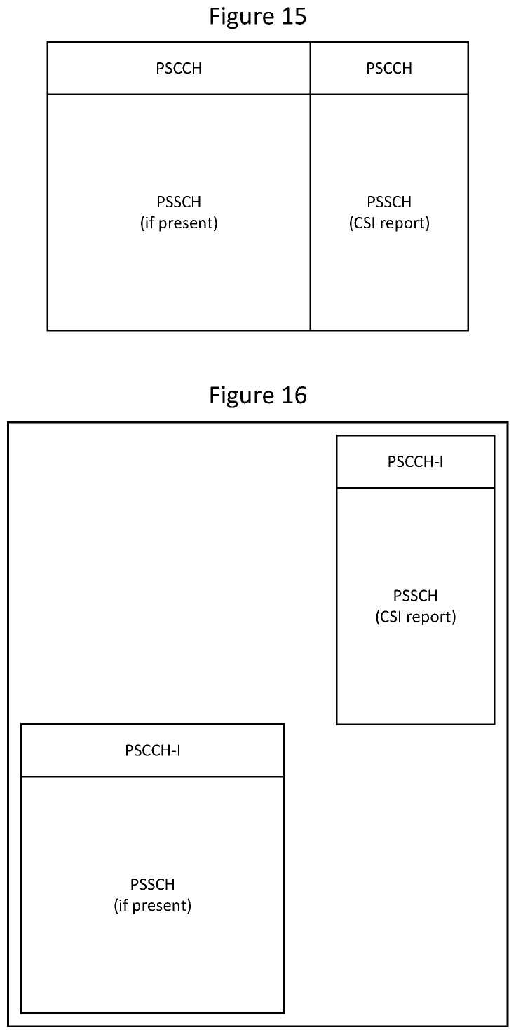

It has been agreed that for sidelink unicast, CSI is delivered using PSSCH (including PSSCH containing CSI only) using the resource allocation procedure for data transmission. Note that for a single UE, it is possible to have two scenarios: 1) CSI report only transmission; 2) simultaneous CSI report and data transmissions. Then, to unify the SCI format design for the two different scenarios, CSI report may have a separate and independent PSCCH even if there is simultaneous data transmission from the same UE. In this way, transmission parameters of the CSI report can be separately adjusted. Also, the number of potential SCI formats are kept low, which eases the blind decoding of PSCCH. An example of transmitting SL CSI reports is illustrated by FIG. 15. As shown in FIG. 15, if data and CSI report are transmitted simultaneously, two parallel transmissions, possibly adjacent in frequency, take place. In other words, the CSI report and other simultaneous transmissions (e.g. data) are two separate transmissions.

FIG. 15 illustrates CSI report transmission using PSSCH.

An eighth proposal is that sidelink CSI report and simultaneous data transmission (if present) are considered as two parallel transmissions and have separate PSCCH.

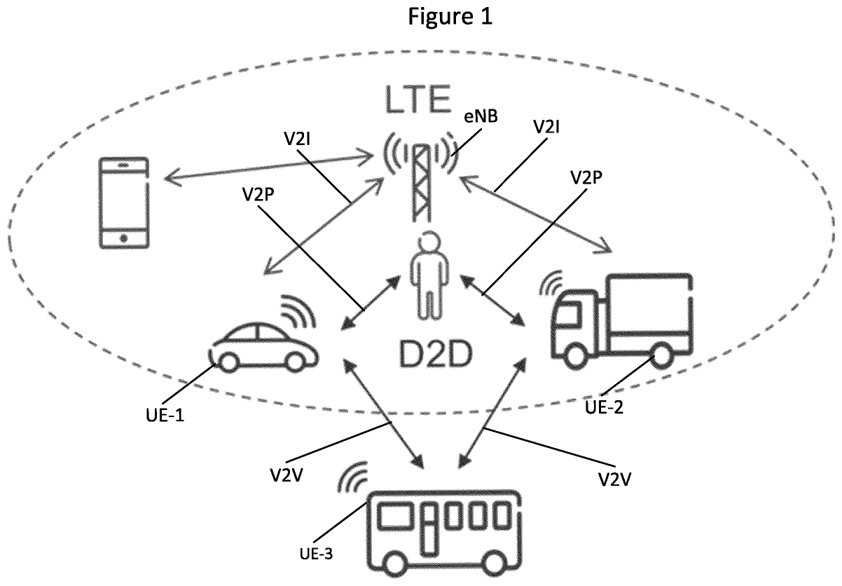

Then, the next question is, how can a UE select resources when it has both CSI report and data to transmit. If the resource selections are totally independent for CSI report and data, it may very likely end up with the situation shown in FIG. 16, i.e., CSI report and data transmissions are neither adjacent in time or frequency. This will bring several potential problems: half-duplex, resource fragmentation, and inter-modulation distortion. Hence, resource selections of CSI report and data transmission may be jointly considered, if they are both present. More specifically, an outcome as illustrated in FIG. 1 should be tried to achieve, i.e., CSI report and data are sent in the same slot and they are adjacent in frequency.

FIG. 16 illustrates Independent resource selections of CSI report and data.

A ninth proposal is that resource selections of CSI report and data transmission should be jointly considered, if they are both present.

In addition, in SL communication between in-coverage UEs scheduled by gNB (i.e. mode-1), CSI reports can be provided via the gNB or directly between the two UEs. However, to keep a unified design for both in-coverage and out-of-coverage scenarios, it is proposed to always transmit CSI reports over sidelink and in case of gNB scheduling (Mode-1) the UE receiving CSI report (i.e., the SL transmitter) may forward it to the gNB.

A tenth proposal is that in case of NR Mode-1, the UE receiving the CSI report over sidelink may forward the CSI report to the serving gNB.

Sidelink CSI-RS is discussed below.

To assist CSIT acquisition (e.g., RI and CQI reports), reference signals are needed. In some cases, sidelink DMRS is enough for this purpose. For example, when the number of DM-RS ports equals to the number of antenna ports, DM-RS can be used at the receive side to derive RI. However, when DM-RS is subject to the same precoding as data transmission (which is also the principle for NR Uu DM-RS), an additional reference signal type is needed for channel and/or interference measurement. Hencefor CSIT acquisition a new type of reference signal called SL CSI reference signal (SCSI-RS) may be introduced. The SCSI-RS should be designed in such a way that it facilitates CSIT acquisition either in a reciprocity-based manner and/or in a feedback-based manner. Also, the support for SCSI-RS makes the design future-proof and allows the introduction of Tx schemes that require the non precoded channel estimates.

An eleventh proposal is that sidelink channel state information reference signals (SCSI-RS) are introduced for CSIT acquisition.

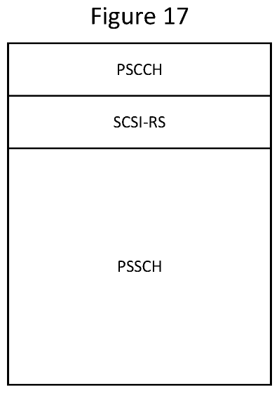

FIG. 17 illustrates a slot structure containing SCSI-RS.

Specifically, when channel reciprocity can be exploited, CSIT can be obtained using SCSI-RS transmitted by the peer UE. On the other hand, when channel reciprocity does not hold, SCSI-RS can be used to measure the channel and/or the interference which are then reported back to the transmitter to facilitate CSIT acquisition, which is considered as SL CSI report. Since SCSI-RS may or may not be present in a slot, SCI transmitted over PSCCH may be used to indicate its presence.

A twelfth proposal is that the presence of SCSI-RS in a slot is indicated by an SCI carried by the PSCCH.

In contrast to the NR Uu interface, the transmission of SCSI-RS should always be confined within the allocated bandwidth for sidelink transmission (as shown in FIG. 17). This allows the efficient coexistence of different types of communications i.e. unicast, multicast and broadcast. Moreover, to further improve efficiency, the SCSI-RS should not use the whole OFDM symbol but is transmitted in a comb manner with data or DM-RS.

A thirteenth proposal is that transmission of SCSI-RS is confined within the allocated bandwidth for sidelink transmission. SCSI-RS is transmitted in a comb manner with data and/or DMRS.

Sidelink open-loop power control is discussed below. In RAN #ah1901 the following agreements were made.
SL open-loop power control is supported.
   For unicast, groupcast, broadcast, it is supported that the open-loop power control is based on the pathloss between TX UE and gNB (if TX UE is in-coverage).
      This is at least to mitigate interference to UL reception at gNB.
      Rel-14 LTE sidelink open-loop power control is the baseline.
      gNB should be able to enable/disable this power control.
   At least for unicast, it is supported that the open-loop power control is also based on the pathloss between TX UE and RX UE.
      (Pre-)configuration should be able to enable/disable this power control.
      FFS whether this is applicable to groupcast
      FFS whether this requires information signaling in the sidelink.
   Further study its potential impact, e.g., on resource allocation.
FFS whether closed-loop power control is additionally needed.

In RAN #96, the following agreements were made.
For unicast RX UEs, SL-RSRP is reported to TX UE
For sidelink open loop power control for unicast for the TX UE, TX UE derives pathloss estimation
   Revisit during the WI phase with respect to whether or not there is a need regarding how to handle pathloss estimation for OLPC before SL-RSRP is available for a RX UE
   TPC commands for SL PC are not supported

The Role of Power Control in Uplink and Sidelink Transmissions is discussed below including: 2 PC formulas from NR/LTE; Inputs to that formula and how it helps to achieve the target of PC; How the max power should be set/configured; and Applicability of SCSI-RS for RSRP feedback for pathloss est.

For SL transmissions, transmit power control serves the following purposes. It helps to adjust the SL range to the intended receiver and ensure good reception of SL packets at the intended receiver(s), while limiting the interference caused at non-intended receivers. Note that when SL operates in licensed spectrum, limiting the interference power can be very important, especially when SL and cellular resources overlap. It helps to manage the UE power consumption, which may be important for certain UE types (e.g. pedestrian UE). This aspect is less important for vehicle UEs.

A first step in formulating the SL power control mechanism is to base it on the NR standard UL power control mechanism. NR Power control for PUSCH transmissions can be simplified to the following expression:

P=min{Pₘₐₓ,P₀+α·PL+10·log₁₀(2^{μ}·M_{RB})+Δ_{TF}+Δ_{TPC}}

The above equation is a combination of both open-loop and closed-loop control with the following parameters:
Pₘₐₓ is the maximum allowed transmit power configured by higher layers;
P₀ is the targeted or base power, configured by higher layers;
α is the fractional path-loss compensation factor configured by higher layers;
PL is the path loss estimation=reference signal power—higher layer filtered RSRP;
μ is related to the subcarrier spacing used for the transmission, whose possible values depend on the numerology;
M_{RB} is the number of resource blocks scheduled for the transmission;
Δ_{TF} and Δ_{TPC} are dynamic offsets to adjust the transmit power taking into account the current modulation and coding scheme (MCS) and explicit transmit power control (TPC) commands from the network.

Since it has been agreed that TPC commands are not supported for SL transmissions, the dynamic offset components Δ_{TF} and Δ_{TPC} should not be included for SL power control. Also, from an implementation perspective, it is advantageous if the transmit power control mechanism does not mandate fast power control for SL transmissions related to fast fading effects.

Open-loop power control adjusts the transmit power by configuring an appropriate path loss compensation factor α, based on the accuracy of the pathloss estimate PL so that the received power at RX UE is more or less equal to the targeted power P₀. The targeted power P₀ is configured depending on the target data rate and/or targeted SNR level, and also the interference level experienced at the RX UE.

A fourteenth proposal is that open loop power control is based on the NR UL power control mechanism using the NR UL power control equation for both mode 1 and mode 2 UEs.

The configuration of the open loop power control parameters in mode 1 and mode 2 is for further study.

Open-loop Power Control for Unicast Transmissions is discussed below including 2 alternatives: No info at the TX about measured noise level and interference at the RX (reduced functionality); and Info made available at TX, allows for “fully fledged” PC on the SL.

For unicast, it is supported that the open-loop power control is based on the pathloss between TX UE and RX UE. The TX UE estimates the pathloss from the SL-RSRP reported by the RX UE. The SL RSRP is calculated based on long-term measurements (layer 3 filtered) of a SL reference signal.

Furthermore, besides receiving SL RSRP from the RX UE, it may also be possible that the Tx UE makes use of SL CSI reports to determine the SINR at the Rx UE. This SINR/interference knowledge can the then be utilized to more accurately set the target P₀ value.

A fifteenth proposal is that additional reporting about interference at the RX UE should be made available to TX UE for more accurate power control configuration.

Power Control for Groupcast and Broadcast Transmissions is discussed below including.

In the case of broadcast/groupcast transmissions, a possible objective of power control is to maximize the number of intended RX UEs that can successfully decode the message without transmitting with full power as this could lead to unnecessary interference.

Like in the unicast cast, if the pathloss between TX UE and RX UE is considered for the power control mechanism, the TX UE will need to keep track of multiple RSRP feedbacks to calculate pathloss to each individual RX UE within the group. This would also require modifications to the power control expression detailed previously to include multiple RXs. Groupcast UEs may not provide SL RSRP feedback to TX UE.

Instead, open loop power control for groupcast is based on the intended communication range specified by the service. The Tx UE sets the transmission power such that the Rx UEs within this range are capable of successfully decoding the message while minimizing interference and maximizing energy efficiency.

A sixteenth proposal is that open loop SL power control for groupcast considers the communication range requirement.

Example embodiments of inventive concepts are set forth below.

1. A method of operating a first wireless device (1100) associated with a group including the first wireless device and a second wireless device, the method comprising: receiving (403, 503) a data packet from the second wireless device of the group; measuring (407, 507) a reference signal received power, RSRP, based on a reference signal received from the second wireless device of the group; and determining (419, 515/517, 515/537) whether or not to transmit Acknowledgement/Negative, ACK/NACK, feedback for the data packet based on a comparison between the RSRP and an RSRP threshold.

2. The method of Embodiment 1, wherein determining comprises determining to transmit ACK/NACK feedback responsive to the RSRP being less than the RSRP threshold, and/or determining to not transmit ACK/NACK feedback responsive to the RSRP being greater than the RSRP threshold.

3. The method of Embodiment 1, wherein determining comprises determining to transmit ACK/NACK feedback responsive to the RSRP being less than the RSRP threshold or responsive to a distance between the first and second wireless devices being greater than a distance threshold, and/or wherein determining comprises determining to not transmit ACK/NACK feedback responsive to the RSRP being greater than the RSRP threshold and responsive to a distance between the first and second wireless devices being less than the distance threshold.

4. The method of any of Embodiments 2-3, wherein the RSRP is less than the RSRP threshold, wherein determining comprises determining to transmit ACK/NACK feedback based on the RSRP being less than the RSRP threshold, the method further comprising: transmitting (427, 435) ACK/NACK feedback for the data packed based on a result of decoding the data packet.

5. The method of Embodiment 4, wherein transmitting comprises transmitting ACK feedback for the data packet responsive to success decoding the data packet, the method further comprising: processing (431) the data packet responsive to success decoding the data packet.

6. The method of Embodiment 4, wherein transmitting comprises transmitting NACK feedback for the data packet responsive to failure decoding the data packet without processing the data packet further.

7. The method of any of Embodiments 2-3, wherein the RSRP is greater than the RSRP threshold, wherein determining comprises determining to not transmit ACK/NACK feedback based on the RSRP being greater than the RSRP threshold.

8. The method of Embodiment 7, further comprising: processing (431) the data packet responsive to success decoding the data packet.

9. The method of Embodiment 1, wherein determining comprises determining to transmit ACK/NACK feedback responsive to the RSRP being greater than the RSRP threshold, and/or determining to not transmit ACK/NACK feedback responsive to the RSRP being less than the RSRP threshold.

10. The method of Embodiment 1, wherein determining comprises determining to transmit ACK/NACK feedback responsive to the RSRP being greater than the RSRP threshold or responsive to a distance between the first and second wireless devices being less than a distance threshold, and/or wherein determining comprises determining to not transmit ACK/NACK feedback responsive to the RSRP being less than the RSRP threshold and responsive to a distance between the first and second wireless devices being greater than the distance threshold.

11. The method of any of Embodiments 9-10, wherein the RSRP is greater than the RSRP threshold, wherein determining comprises determining to transmit ACK/NACK feedback based on the RSRP being greater than the RSRP threshold, the method further comprising: transmitting (427, 435) ACK/NACK feedback for the data packed based on a result of decoding the data packet.

12. The method of Embodiment 11, wherein transmitting comprises transmitting ACK feedback for the data packet responsive to success decoding the data packet, the method further comprising: processing (431) the data packet responsive to success decoding the data packet.

13. The method of Embodiment 11, wherein transmitting comprises transmitting NACK feedback for the data packet responsive to failure decoding the data packet without processing the data packet further.

14. The method of any of Embodiments 9-10, wherein the RSRP is less than the RSRP threshold, wherein determining comprises determining to not transmit ACK/NACK feedback based on the RSRP being less than the RSRP threshold.

15. The method of Embodiment 14, further comprising:

processing (431) the data packet responsive to success decoding the data packet.

16. The method of any of Embodiments 3 or 10, wherein the distance threshold is determined based on a communication range requirement of the data packet.

17. The method of any of Embodiments 3, 10, or 16, wherein the distance threshold is based on a configuration received from a radio access network.

18. The method of any of Embodiments 3, 10, 16, or 17, wherein the distance between the first and second wireless devices is derived based on global positioning system, GPS, information for the first wireless device, based on GPS information received from the second wireless device, based on an area identifier for the first wireless device assigned by a radio access network, and/or based on an area identifier for the second wireless device received from the second wireless device.

19. The method of Embodiment 1, wherein determining comprises determining to not transmit ACK feedback responsive to the RSRP being greater than the RSRP threshold and responsive to successfully decoding the data packet.

20. The method of Embodiment 19, further comprising: processing (541) the data packet responsive to the RSRP being greater than the RSRP threshold and responsive to successfully decoding the data packet.

21. The method of Embodiment 1, wherein determining comprises determining to transmit NACK feedback responsive to the RSRP being greater than the RSRP threshold and responsive to failure decoding the data packet.

22. The method of Embodiment 21 further comprising: transmitting (519) NACK feedback for the data packet responsive to the RSRP being greater than the RSRP threshold and responsive to failure decoding the data packet.

23. The method of Embodiment 1, wherein determining comprises determining to not transmit NACK feedback responsive to the RSRP being less than the RSRP threshold and responsive to failure decoding the data packet.

24. The method of Embodiment 1, wherein determining comprises determining to transmit ACK feedback responsive to the RSRP being less than the RSRP threshold and responsive to success decoding the data packet.

25. The method of Embodiment 24 further comprising: transmitting (539) ACK feedback for the data packet responsive to the RSRP being less than the RSRP threshold and responsive to success decoding the data packet.

26. The method of Embodiment 25, further comprising: processing (541) the data packet responsive to the RSRP being less than the RSRP threshold and responsive to success decoding the data packet.

27. The method of any of Embodiments 1-26, wherein the RSRP threshold is determined based on a configuration received form a radio access network.

28. The method of any of Embodiments 19-20, wherein the data packet is a first data packet, wherein the RSRP is a first RSRP, and wherein the RSRP threshold is a first RSRP threshold, the method further comprising: receiving (503) a second data packet from the second wireless device of the group; measuring (507) a second RSRP associated with the second wireless device; determining (515/517) to not transmit NACK feedback for the second data packet responsive to the second RSRP being less than a second RSRP threshold and responsive to failure decoding the second data packet.

29. The method of Embodiment 28, wherein the first and second RSRP thresholds are different.

30. The method of Embodiment 28, wherein the first and second RSRP thresholds are the same.

31. The method of any of Embodiments 1-30, wherein the RSRP threshold is determined at the first wireless device based on a known transmission power used by the second wireless device to transmit the reference signal.

32. The method of any of Embodiments 1-30, wherein the RSRP threshold is determined at the first wireless device based on an estimate of transmission power used by the second wireless device to transmit the reference signal.

33. The method of any of Embodiments 1-32, wherein measuring the RSRP comprises measuring the RSRP using at least one of a demodulation reference signal, DMRS, a sounding reference signal, SRS, and/or a channel state information reference signal, CSI-RS.

34. The method of any of Embodiments 1-33, wherein the RSRP threshold is determined by the first wireless device based on at least one of a quality of service, QoS, parameter associated with the group, a communication range requirement of a service associated with the group, and/or a channel congestion level.

35. The method of any of Embodiments 1-34, wherein the first wireless device is a first vehicle-to-vehicle, V2X, wireless device, and wherein the second wireless device is a second V2X wireless device.

36. A first wireless device (1100) comprising: a processor (1103); and memory (1105) coupled with the processor, wherein the memory includes instructions that when executed by the processor causes the first wireless device to perform operations according to any of Embodiments 1-35.

37. A wireless device (1100) wherein the wireless device is adapted to perform according to any of Embodiments 1-35.

38. A computer program comprising program code to be executed by at least one processor (1103) of a wireless device (1100), whereby execution of the program code causes the wireless device (1100) to perform a method according to any one of embodiments 1-35.

39. A computer program product comprising a non-transitory storage medium including program code to be executed by at least one processor (1103) of a wireless device (1100), whereby execution of the program code causes the wireless device (1100) to perform a method according to any one of embodiments 1-35.

Explanations for abbreviations from the above disclosure are provided below.

### Abbreviation Explanation

ACK Acknowledgement
AGC Automatic gain control
BS Base Station
BSM Basic Safety Message
BSR Buffer Status Report
CSI Channel State Information
CSI-RS Channel state information reference signal
CSIT Channel state information at the transmitter
CAM Cooperative awareness message
CB Code Block
CBG Code Block Group
CQI Channel Quality Indicator
D2D Device-to-device communication
DENM Decentralized Environmental Notification Message
DM-RS Demodulation reference signals
DTX Discontinuous Transmission
FFS For Further Study
gNB gNodeB (Radio Access Base Station)
GP Guard period
HARQ Hybrid automatic repeat request
LTE Long-term evolution
MCS Modulation and coding schemes
NACK Negative acknowledgement
NR New radio
NW Network
OFDM Orthogonal frequency division multiplexing
OLPC Open Loop Power Control
PC Power Control
PL Path Loss
PHY Physical layer
PMI Precoding Matrix Indicator
ProSe Proximity-based services
PSCCH Physical sidelink control channel
PSFCH Physical Sidelink Feedback CHannel
PSSCH Physical sidelink shared channel
PUCCH Physical Uplink Control CHannel
QoS Quality of Service
RI Rank Indicator
RS Reference Signal
RSRP Reference Signal Received Power
RX Receiver
SAE Society of the Automotive Engineers
SCI Sidelink control information
SI Study item
SCSI-RS Sidelink CSI-RS
SR Scheduling Request
SL SideLink
TB Transport Block
TPC Transmit Power Control
TTI Transmission time interval
TX Transmitter
UE User Equipment
Uu link Link between UE and Base Station
V2I Vehicle-to-infrastructure
V2P Vehicle-to-pedestrian
V2V Vehicle-to-vehicle
V2X Vehicle-to-anything communication
eV2X enhanced Vehicle-to-anything communication
WI Work Item (3GPP)

Citations are provided below for references cited herein.
Reference [1] RP-190766, New WID on 5G V2X with NR sidelink, 3GPP TSG RAN Meeting #83, March 2019.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 6: A wireless network in accordance with some embodiments.

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network QQ106, network nodes QQ160 and QQ160b, and WDs QQ110, QQ110b, and QQ110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units.

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 6 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

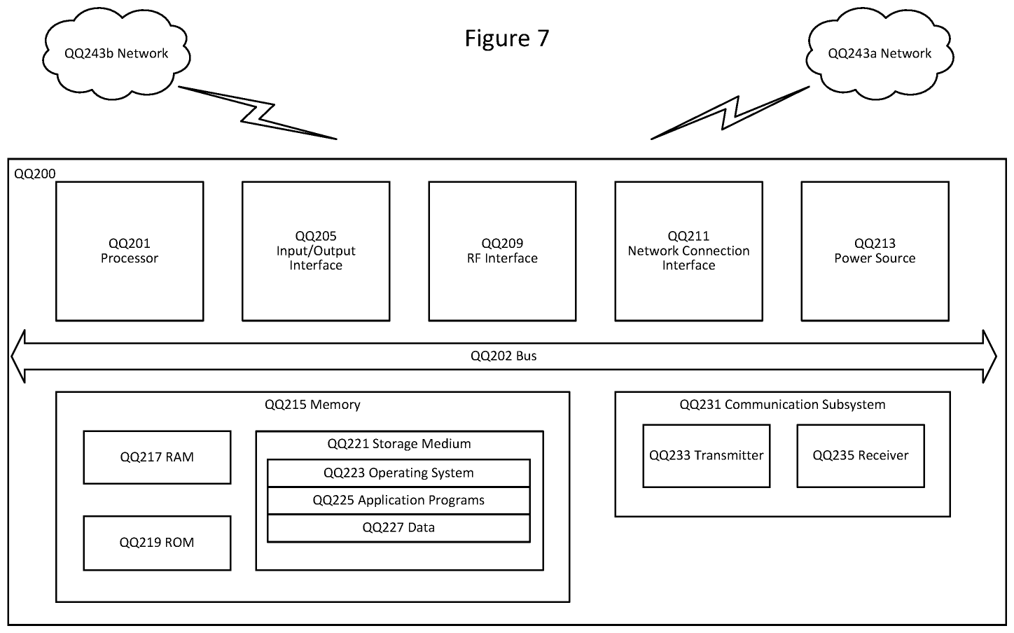

FIG. 7: User Equipment in accordance with some embodiments

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ2200 may be any UE identified by the 3rd Generation Partnership Project (3GPP), including a NB-IoT UE, a machine type communication (MTC) UE, and/or an enhanced MTC (eMTC) UE. UE QQ200, as illustrated in FIG. 7, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. 7, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.QQ2, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

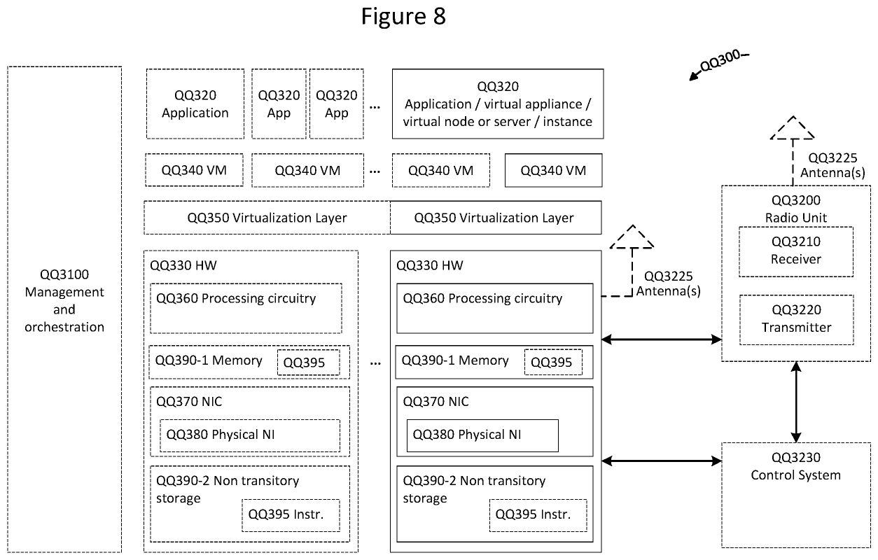

FIG. 8: Virtualization environment in accordance with some embodiments

FIG. 8 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. 8, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. 8.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be effected with the use of control system QQ3230 which may alternatively be used for communication between the hardware nodes QQ330 and radio units QQ3200.

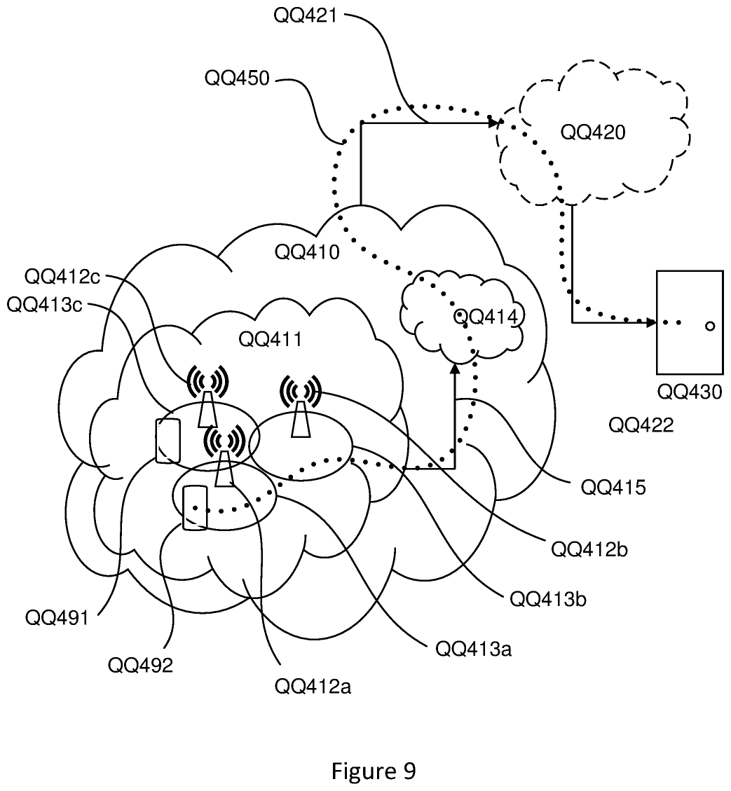

FIG. 9: Telecommunication network connected via an intermediate network to a host computer in accordance with some embodiments.

With reference to FIG. 9, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 9 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

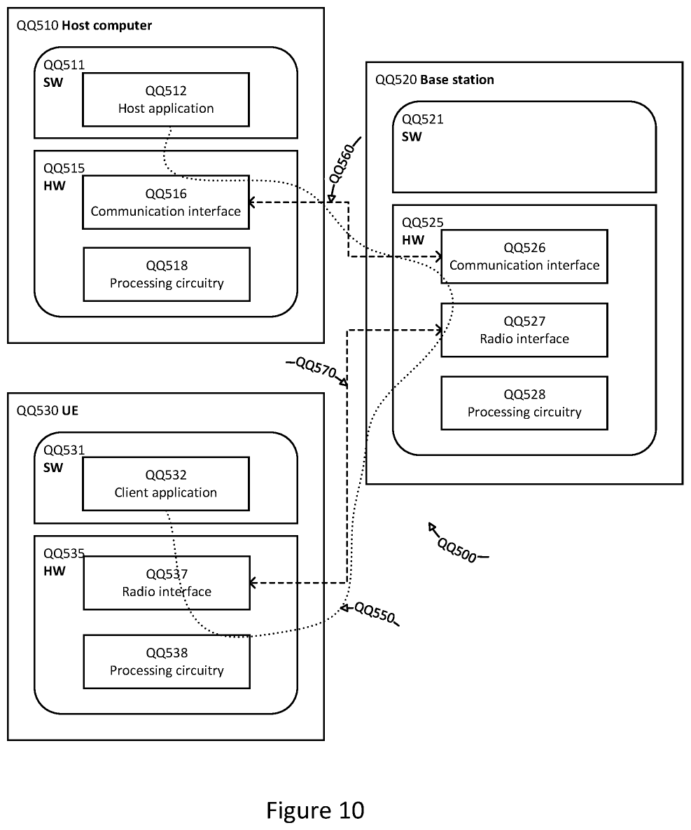

FIG. 10: Host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 10. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 10) served by base station QQ520. Communication interface QQ526 may be configured to facilitate connection QQ560 to host computer QQ510. Connection QQ560 may be direct or it may pass through a core network (not shown in FIG. 10) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. 10 may be similar or identical to host computer QQ430, one of base stations QQ412a, QQ412b, QQ412c and one of UEs QQ491, QQ492 of FIG. 9, respectively. This is to say, the inner workings of these entities may be as shown in FIG. 10 and independently, the surrounding network topology may be that of FIG. 9.

In FIG. 10, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments may improve the performance of OTT services provided to UE QQ530 using OTT connection QQ550, in which wireless connection QQ570 forms the last segment. More precisely, the teachings of these embodiments may improve the deblock filtering for video processing and thereby provide benefits such as improved video encoding and/or decoding.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

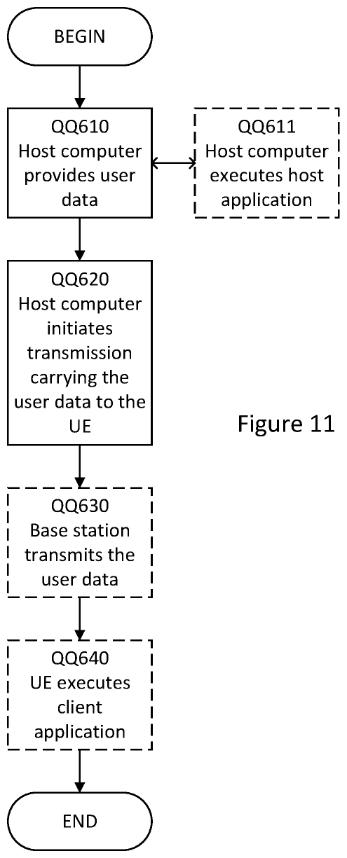

FIG. 11: Methods implemented in a communication system including a host computer, a base station and a user equipment in accordance with some embodiments.

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

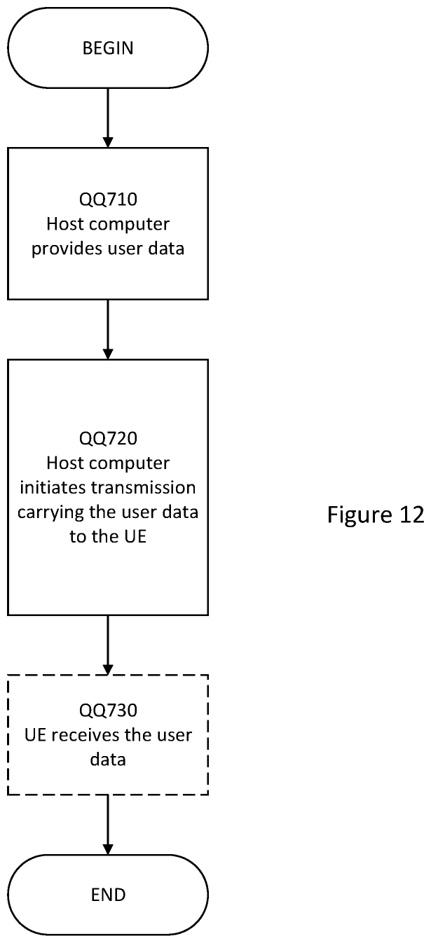

FIG. 12: Methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

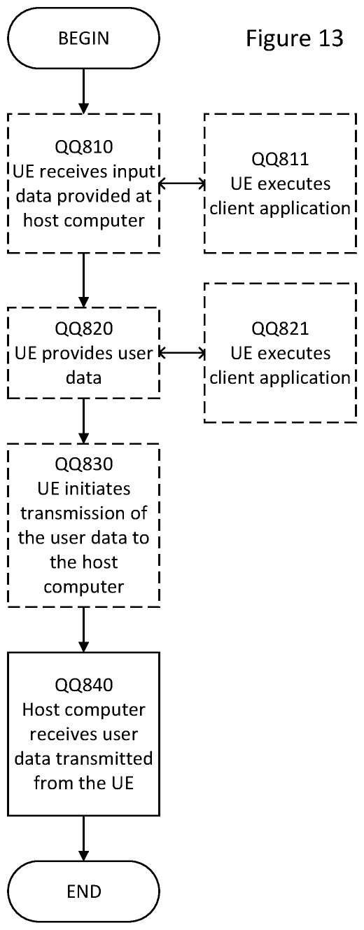

FIG. 13: Methods implemented in a communication system including a host computer, a base station and a user equipment in accordance with some embodiments.

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

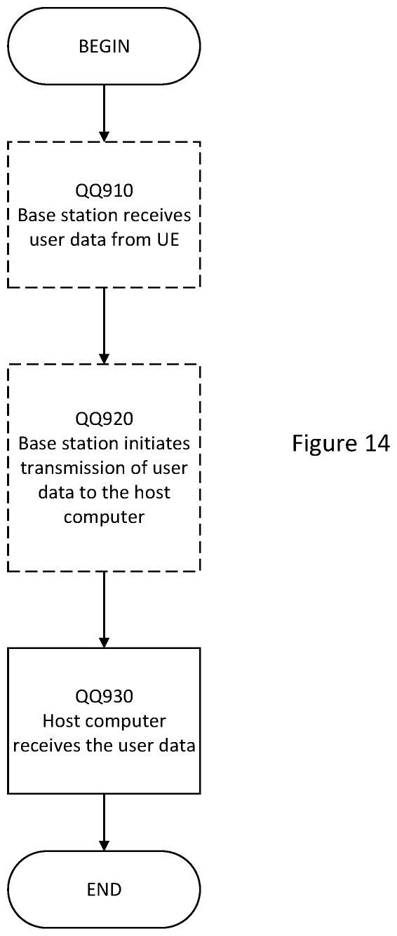

FIG. 14: Methods implemented in a communication system including a host computer, a base station and a user equipment in accordance with some embodiments.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method of operating a first wireless device associated with a group including the first wireless device and a second wireless device, the method comprising:
receiving a data packet from the second wireless device of the group;
measuring a reference signal received power, RSRP, based on a reference signal received from the second wireless device of the group; and
determining whether or not to transmit Acknowledgement/Negative, ACK/NACK, feedback for the data packet based on a comparison between the RSRP and an RSRP threshold.

2. (canceled)

3. The method of claim 1, wherein determining comprises determining to transmit ACK/NACK feedback responsive to the RSRP being less than the RSRP threshold or responsive to a distance between the first and second wireless devices being greater than a distance threshold, and/or wherein determining comprises determining to not transmit ACK/NACK feedback responsive to the RSRP being greater than the RSRP threshold and responsive to a distance between the first and second wireless devices being less than the distance threshold.

4. The method of claim 2, wherein the RSRP is less than the RSRP threshold, wherein determining comprises determining to transmit ACK/NACK feedback based on the RSRP being less than the RSRP threshold, the method further comprising:
transmitting ACK/NACK feedback for the data packed based on a result of decoding the data packet.

5-6. (canceled)

7. The method of claim 1, wherein determining comprises determining to transmit ACK/NACK feedback responsive to the RSRP being greater than the RSRP threshold or responsive to a distance between the first and second wireless devices being less than a distance threshold, and/or wherein determining comprises determining to not transmit ACK/NACK feedback responsive to the RSRP being less than the RSRP threshold and responsive to a distance between the first and second wireless devices being greater than the distance threshold.

8-9. (canceled)

10. The method of claim 3, wherein the distance threshold is determined based on a communication range requirement of the data packet.

11. (canceled)

12. The method of claim 3, wherein the distance between the first and second wireless devices is derived based on global positioning system, GPS, information for the first wireless device, based on GPS information received from the second wireless device, based on an area identifier for the first wireless device assigned by a radio access network, and/or based on an area identifier for the second wireless device received from the second wireless device.

13. The method of claim 1, wherein determining comprises determining to not transmit ACK feedback responsive to the RSRP being greater than the RSRP threshold and responsive to successfully decoding the data packet;
wherein the data packet is a first data packet, wherein the RSRP is a first RSRP, and wherein the RSRP threshold is a first RSRP threshold, the method further comprising:
receiving a second data packet from the second wireless device of the group;
measuring a second RSRP associated with the second wireless device; and
determining to not transmit NACK feedback for the second data packet responsive to the second RSRP being less than a second RSRP threshold and responsive to failure decoding the second data packet, wherein the first and second RSRP thresholds are different.

14-20. (canceled)

21. The method of claim 1, wherein the RSRP threshold is determined at the first wireless device based on one or more of:
a known transmission power used by the second wireless device to transmit the reference signal,
an estimate of transmission power used by the second wireless device to transmit the reference signal, and
at least one of a quality of service, QoS, parameter associated with the group, a communication range requirement of a service associated with the group, and/or a channel congestion level.

22-24. (canceled)

25. The method of claim 1, wherein the first wireless device is a first vehicle-to-vehicle, V2X, wireless device, and wherein the second wireless device is a second V2X wireless device.

26. A first wireless device comprising:
a processor; and
memory coupled with the processor, wherein the memory includes instructions that when executed by the processor causes the first wireless device to,
receive a data packet from a second wireless device of a group, wherein the group includes the first wireless device and the second wireless device,
measure a reference signal received power, RSRP, based on a reference signal received from the second wireless device of the group, and
determine whether or not to transmit Acknowledgement/Negative, ACK/NACK, feedback for the data packet based on a comparison between the RSRP and an RSRP threshold.

27-30. (canceled)

31. A computer program product comprising a non-transitory storage medium including program code to be executed by at least one processor of a first wireless device, whereby execution of the program code causes the first wireless device to perform a method comprising:
receiving a data packet from a second wireless device of a group including the first wireless device and a second wireless device;
measuring a reference signal received power, RSRP, based on a reference signal received from the second wireless device of the group; and
determining whether or not to transmit Acknowledgement/Negative, ACK/NACK, feedback for the data packet based on a comparison between the RSRP and an RSRP threshold.

32. The computer program product of claim 31, wherein determining comprises determining to not transmit ACK feedback responsive to the RSRP being greater than the RSRP threshold and responsive to successfully decoding the data packet;
wherein the data packet is a first data packet, wherein the RSRP is a first RSRP, and wherein the RSRP threshold is a first RSRP threshold, the method further comprising:
receiving a second data packet from the second wireless device of the group;
measuring a second RSRP associated with the second wireless device; and
determining to not transmit NACK feedback for the second data packet responsive to the second RSRP being less than a second RSRP threshold and responsive to failure decoding the second data packet, wherein the first and second RSRP thresholds are different.

33. The first wireless device of claim 26, wherein the instructions cause the first wireless device to determine to transmit ACK/NACK feedback responsive to the RSRP being less than the RSRP threshold or responsive to a distance between the first and second wireless devices being greater than a distance threshold, and/or wherein the instructions cause the first wireless device to determine to not transmit ACK/NACK feedback responsive to the RSRP being greater than the RSRP threshold and responsive to a distance between the first and second wireless devices being less than the distance threshold.

34. The first wireless device of claim 26, wherein the RSRP is less than the RSRP threshold, wherein the instructions cause the first wireless device to determine to transmit ACK/NACK feedback based on the RSRP being less than the RSRP threshold, and to transmit ACK/NACK feedback for the data packed based on a result of decoding the data packet.

35. The first wireless device of claim 26, wherein the instructions cause the first wireless device to determine to transmit ACK/NACK feedback responsive to the RSRP being greater than the RSRP threshold or responsive to a distance between the first and second wireless devices being less than a distance threshold, and/or wherein the instructions cause the first wireless device to determine to not transmit ACK/NACK feedback responsive to the RSRP being less than the RSRP threshold and responsive to a distance between the first and second wireless devices being greater than the distance threshold.

36. The first wireless device of claim 33, wherein the distance threshold is determined based on a communication range requirement of the data packet.

37. The first wireless device of claim 33, wherein the distance between the first and second wireless devices is derived based on global positioning system, GPS, information for the first wireless device, based on GPS information received from the second wireless device, based on an area identifier for the first wireless device assigned by a radio access network, and/or based on an area identifier for the second wireless device received from the second wireless device.

38. The first wireless device of claim 26, wherein the instructions cause the first wireless device to determine to not transmit ACK feedback responsive to the RSRP being greater than the RSRP threshold and responsive to successfully decoding the data packet;
wherein the data packet is a first data packet, wherein the RSRP is a first RSRP, and wherein the RSRP threshold is a first RSRP threshold, and wherein the instructions further cause the first wireless device to:
receive a second data packet from the second wireless device of the group;
measure a second RSRP associated with the second wireless device; and
determine to not transmit NACK feedback for the second data packet responsive to the second RSRP being less than a second RSRP threshold and responsive to failure decoding the second data packet, wherein the first and second RSRP thresholds are different.

39. The first wireless device of claim 26, wherein the RSRP threshold is determined at the first wireless device based on one or more of:
a known transmission power used by the second wireless device to transmit the reference signal,
an estimate of transmission power used by the second wireless device to transmit the reference signal, and
at least one of a quality of service, QoS, parameter associated with the group, a communication range requirement of a service associated with the group, and/or a channel congestion level.

40. The first wireless device of claim 26, wherein the first wireless device is a first vehicle-to-vehicle, V2X, wireless device, and wherein the second wireless device is a second V2X wireless device.
